(19) United States
(12) Patent Application Publication
(10) Pub. No.: US 2002/0143579 A1
(43) Pub. Date: Oct. 3, 2002

(54) System and method for targeted interventions of physician prescription practices based on deviations from expert guidelines

(76) Inventors: John P. Docherty, Bedford, NY (US); Daniel Carpenter, Fairfield, CT (US); Richard Surles, Ringoes, NJ (US)

Correspondence Address: NATH & ASSOCIATES, 1030 15th STREET, 6TH FLOOR, WASHINGTON, DC, 20005, US

(21) Appl. No.: 09/968,726

(22) Filed: Oct. 2, 2001

Related U.S. Application Data
(60) Provisional application No. 60/279,692, filed on Mar. 30, 2001.

(51) Int. Cl. G06F 17/60

(52) U.S. Cl. 705/2

(57) ABSTRACT

Systems, methods and computer program products for collecting and analyzing information relating to a physician's prescription practice in relation to expert best practice guidelines are disclosed. Information relating to a patient specific prescription is collected and analyzed with respect to established expert best practice guidelines. When deviations from the best practice guidelines are identified a tiered intervention information is generated to the physician identifying the nature of the deviation and including suggested changes in the physician's prescription practice.

### FIELD OF THE INVENTION

This invention relates generally to systems, methods and computer program products for evaluating prescription practices of a physician in relation to an expert best practice protocol, and further includes a targeted information intervention when an observed prescription practice deviates from said best practice protocol.

### BACKGROUND OF THE INVENTION

In recent years increases in the cost of health care has far outpaced other consumer costs. Increasingly employer sponsors of employee health benefit plans and individual consumers have flocked to Health Maintenance Organizations (HMOs) and Preferred Provider Organizations (PPOs) because of their commitment to, and focus on, managing and controlling these escalating costs.

A significant portion of these increased costs represents an inability to appropriately coordinate or target the appropriate medications and/or treatment for individual patients. Although hospital staff members, numerous health care providers and representatives of the pharmaceutical research and development industry play an important decision-making role in determining the treatment for a disease or condition, that role is still ancillary to the patient's primary care physician who diagnoses a patient's problem and prescribes an individualized treatment regimen.

An important professional activity undertaken by most physicians during the course of their day is the prescribing of therapeutic drugs. Many physicians prescribe a great number of drugs every day. Studies show that over two thirds of all doctor-patient encounters were completed with the writing of a prescription. While most physicians exercise the utmost of professional skill and caution in prescribing, there are inherent difficulties and uncertainties in the process. It has been suggested that most physicians do not have access to adequate, reliable drug information and relevant patient information at the time and point of prescribing. In particular, information regarding relevant new drugs, comparative efficacy, interactions, contraindications, and importantly, relative costs, may not be readily and conveniently available to a physician creating a new prescription.

Additionally, relevant patient information such as known allergies or other patient-specific contraindications, as well as other conditions currently being treated, other current treatments, and preferred medications for conditions pursuant to the requirements of the patient's drug formulary, may also not be readily available. As used herein, the term “drug formulary” refers to a list of preferred drugs contained in a drug benefits plan issued by a drugs benefit provider to a given patient.

Drug formularies are specific to groups of patients and vary in content as between one drug benefit provider and another and one patient group and another. Drug formulary information is usually determinative of the cost-effectiveness of a prescription. Unwitting failure by a prescribing physician to follow formulary guidelines can impose unnecessary or unexpected cost burdens on the patient, and their benefits provider, and lead to poor patient compliance and aggravating and time-consuming disputes. The cost in dollars of non-compliance with drug formulary guidelines to benefit-providing corporations, insurers, health maintenance organizations and government providers, can be enormous. The cost of poor patient compliance may ultimately increase the total cost of care by generating a more serious, expensive adverse health outcome such as an emergency room visit, or hospital admission or even death.

Integrated patient-specific information which is directly relevant to treatment management for a patient is frequently both unavailable to, and unobtainable by, a prescribing physician unless that physician's institution or organization has been exhaustively responsible for the patient's prior care and maintains sophisticated computerized records. Information as to allergies, current prescriptions and currently active conditions and formularies is clearly desirable or essential for intelligent prescribing. However, few prescribing sessions are conducted with the benefits of fully integrated patient-specific information and fewer still have the benefit of specific drug formulary recommendations for the subject patient.

After consulting with a patient to determine their problems and diagnosing, or attempting to diagnose, their condition or disease, a physician selects a drug and a dosage and an amount to prescribe based upon their own personal knowledge and experience, if necessary using available reference materials which may or may not include published treatment guidelines, promotional materials from drug manufacturers, health-plan formularies and a full knowledge of available alternative drugs. A prescription is then written which bears a patient identification, a drug name, dosage amount, timing of administration, refills available, permissibility of generic substitution, the physician's signature, the date, and possibly an advisory regarding contraindications, and little other information.

Additionally, therapeutic treatment regimens are continuously becoming increasingly complex. New data and new therapeutic treatment regimens continue to modify the treatments available, and it is difficult for all but the specialist to remain current on all the latest treatment information. Even those who are current on the latest treatment information require time to assimilate that information and understand how it relates to other treatment information in order to provide the best available care for a patient. Additionally, combination therapeutic treatment regimens exacerbate this problem by increasing the complexity of potential drug interactions. Finally, an increasingly educated and sophisticated patient population, in the face of a vast volume of consumer information on the treatment of disease and rapidly increasing volume of pharmaceutical advertising, makes the mere statement of a treatment regime and the prescription of a therapeutic drug, without explanation, difficult for the patient to accept.

Numerous prior art attempts have been made to better manage physician prescription practices in light of these available information resources, the growing number of available prescription drugs and the growing prevalence of formularies.

### DESCRIPTION OF THE RELATED ART

U.S. Pat. No. 6,188,988 to Barry et al., incorporated herein by reference, discloses a method and apparatus for guiding selection of a therapeutic treatment regimen for a known disease. The method includes evaluating patient information in relation to a plurality of different therapeutic treatment regimens for a diagnosed disease based on a plurality of expert rules for selecting a therapeutic treatment regimen for the disease. Based on patient information and the expert rules, a list of therapeutic treatment regimens for the patient is prepared which includes advisory information for one or more treatment regimens.

U.S. Pat. No. 6,067,524 to Byerly et al., incorporated herein by reference, discloses a dispensing pharmacy based system and a related method for automatically providing advisory information to pharmacy patients based on the identification of the drugs being dispensed and/or other information pertaining to the patient and to the prescription and/or patient-specific information provided by a third party, such as an HMO, PPO, etc.

U.S. Pat. No. 6,029,138 to Khorasani et al., incorporated herein by reference, discloses a medication review system wherein a relative frequency with which a treatment regimen has been prescribed for a particular diagnosis code is determined. The relative percentage is compared to a threshold to determine whether a physicians proposed treatment regimen should be accepted. If accepted, feedback, such as the relative frequency with significant therapeutic results of the proffered treatment regimen, can be provided to the ordering physician. Alternative therapeutic treatment can also be suggested by reference to data extracted from existing scientific literature, or by searching for other treatment regimens having the same diagnostic indications but more significant therapeutic results.

U.S. Pat. No. 6,014,631 to Teagarden et al., incorporated herein by reference, discloses a system wherein, in response to a patient initiated request, a computer program gathers a patient's therapeutic history including a complete history of medication use, adverse effects, treatment goals, medical history, and patient concerns and satisfaction. A medication profile, including information on current medications and adverse effects, is created and analyzed to evaluate various drug related problems. The patient's physician is contacted to, for example, verify current medications, discuss potential interventions, establish therapeutic goals, verify adverse drug reactions, and discuss compliance issues. A summary letter is sent to the physician, and a summary of therapy changes is sent to the patient. A call from a pharmacist to the patient, and a health status survey is also sent to the patient. Examples of drug related problems can include: untreated indications, and including therapeutic failures; drug use without an indication; improper drug selection, and including therapeutic duplications; improper dosage; interactions, e.g., drug-drug, drug-food and drug-disease; inadequate drug delivery, and including non-compliance; adverse reactions; and improper monitoring.

U.S. Pat. Nos. 5,953,704 and 5,583,758 to McIlroy et al., incorporated herein by reference, discloses a data base of diagnosis-based guidelines developed by medical professionals and provides a diagnosis based system that can be used during various steps of the clinical decision process. A user inputs an individual's health data into a case file in response to inquiries implemented in a health-condition specific guideline. A guideline treatment option (or options) is obtained. The user may adopt or accept the guideline treatment option(s) or input an alternative actual or proposed treatment. Discrepancies between actual or proposed and guideline treatment option(s) are identified and the physician's choice is documented. Once a treatment is selected, the case information is added to the data base and a reviewer can analyze the file. Once guideline treatment options are identified, the system elicits from the user information identifying the actual treatment already given or, preferably, the treatment proposed for the individual that presented the health care condition. The system compares the actual or proposed treatment against the guideline treatment option(s). The system develops a treatment evaluation based on the comparison to identify discrepancies between the guideline treatment option and the actual or proposed treatment. If the proposed treatment differs from the guideline treatment option, the system elicits information on the reasons for the difference(s) found in the system's comparison.

U.S. Pat. No. 5,924,074 to Evans, incorporated herein by reference, discloses a system having medication data and guideline data and which includes patient data and practice guidelines. The practice guidelines provide references for practitioners to consult regarding courses of action to obtain a diagnosis and alternative treatments for various conditions. A physician can review the patient's history by viewing a medication history and a diagnosis history before prescribing any new medications. The physician selects a medication by entering the name of the medication. If there are no contraindications or allergies for the patient, the physician can prescribe the medication. Otherwise, if a contraindication exists, a warning appears to alert the physician. In view of the warning, the physician can investigate the effects of the medication. A medication's interactions is provided. An allergy list displays the patient's allergens. The physician can then evaluate the information on the interactions, including potential adverse patient reactions. The physician can make any needed revisions to the medications selected.

U.S. Pat. No. 5,924,073 to Tyuluman et al., incorporated herein by reference, discloses a system and method for analyzing and defining a standard of care that identifies components of patient care which are more costly to implement, have greater risk exposure, or include ineffective treatment, compared to recommended methods that attain the same or better results for a patient. A standard of care that should be followed based on the characteristics of a particular patient is provided. Physicians who are able to deliver the same or better treatment with significantly lower cost or less exposure to risk are identified as performing above the standard of care. The methods of these physicians are evaluated and made available to the health care community at large. The standard of care is progressively and automatically redefined in an effort to continuously improve the overall quality and cost of care.

U.S. Pat. No. 5,845,255 to Mayaud, incorporated herein by reference, discloses a drug management system classified by conditions for which they are known to have a therapeutic effect.

Based on a patient's condition, the system provides a list of suggested drugs for treating the condition. Drug selection can be refined into categories such as relative cost, relative frequency prescribed, and generic vs. brand name. Where multiple drugs are available for treating an active condition, multiple lines of therapeutic preference according to drug formulary guidelines can be provided. Different suggestions can be provided for different patients according to the preferences of the patient's particular drugs benefit plan, and the resultant prescribing practices of a physician can be reviewed and analyzed by a health benefit plan, such as an HMO, to assess physician compliance.

Where the physician knows that formulary drugs in a similar class have been tried and found ineffective and that the condition is beyond first line treatments, the physician can select a non-formulary drug or a drug in a different chemical category having different therapeutic properties from those previously applied.

Feedback can be provided that the selected drug is a non-formulary drug or is not on the patient's prescription benefit company's schedule. The system can optionally scan a drug preference database, maintained, for example, by a managed care organization, HMO, or prescription benefits management company, and the selected patient's history record for an evaluation of the merits of the selected drug for treating the condition. A message, advising the physician that the selected drug is not a first line drug for treating the selected condition can be provided. In accordance with the benefit company's standards or based on objective literature reports, alternative drugs from listings in the drug preference database can be suggested as more meritorious in treatment of the condition in question. Treatment information can include literature references supporting the system's recommendation. Optionally a copy of such a study can be provided to the physician. Available treatment guidelines information can include details of the particular conditions for which a suggested alternative drug has been found effective, adverse conditions, preferred dosages and administration routes, and literature sources.

U.S. Pat. No. 5,724,379 to Perkins et al., incorporated herein by reference, discloses a method of classifying health care services provided to a patient group based on an objective quantifiable metric. Performance metrics can be identified for the population group. Individual metrics for each of a set of identified service providers can be compared to corresponding population based metrics. Feed back is provided to providers whose individual performance metric deviates significantly from the larger population based metric so that the service provider can alter their behavior in conformance with the broader population based metric. Similar comparative information is provided to benefits providers such as HMOs.

In spite of the numerous existing or published patents, there remains a need for a system and method that, solely in reliance on prescription data, can provide clinically and economically meaningful data analysis of physician prescribing practices; and which, based on this analysis, can recommend targeted interventions to produce measurable changes at the patient, practitioner and health plan levels.

### SUMMARY OF THE INVENTION

Accordingly, it is an object of the present invention to improve clinical outcomes and to promote cost effective prescribing practices without the use of a prior authorization or restriction to a pharmacy formulary by monitoring and intervening, where appropriate, to improve the quality of clinical care, utilizing easy to recover prescription data for profiling physician prescribing practices that are less than optimum.

It is a further object of the present invention to provide an automated system and method to identify physicians whose prescribing practices result in abnormally high prescription costs as compared to other physicians.

It is a further object of the present invention to provide an automated system and method to identify patients whose prescription costs are abnormally high as compared to other patients with similar conditions.

It is a further object of the present invention to provide an automated system and method to identify instances where high cost drugs therapies are being prescribed where alternative lower cost drug therapies are available.

It is yet a further objective of the present invention to provide an automated system and method to identify organizations, or groups whose population's per-capita prescription costs are abnormally high as compared to per-capita prescription costs of other group populations.

An object of a particularly preferred embodiment of the present invention is to identify physician prescribing practices involving excess dosing in comparison to expert dosing guidelines.

A further object of a particularly preferred embodiment of the present invention is to identify physician prescribing practices involving inadequate or ineffective dosing in comparison to expert dosing guidelines.

A further object of a particularly preferred embodiment of the present invention is to identify physician prescribing practices with the potential for drug-drug interactions.

A further object of a particularly preferred embodiment of the present invention is to identify physician prescribing practices involving cost-ineffective pill strength selection.

A further object of a particularly preferred embodiment of the present invention is to identify physician prescribing practices involving use of two or more drugs from the same chemical class.

A further object of a particularly preferred embodiment of the present invention is to identify prescription discontinuance histories and untimely refills.

A further object of a particularly preferred embodiment of the present invention is to identify physician prescribing practices involving use of brand-name drugs where generic equivalents are available.

A further object of a particularly preferred embodiment of the present invention is to identify patients having multiple prescribing physicians who may not be aware of the existence of each other, with respect to that particular patient, and therefore may be unaware of other drugs that may have been prescribed by the other physician.

An object of a particular embodiment of the present invention involving behavioral pharmaceuticals is to identify therapeutic duplications of atypical anti-psychotic medications.

An further object of a particular embodiment of the present invention involving behavioral pharmaceuticals is to identify use of sedatives/hypnotics for greater than 30 days.

These and other objects of the present invention are achieved by a highly targeted strategy that finds opportunities for direct physician intervention to improve prescribing practices, to improve patient compliance, and to assist physicians in obtaining the most current information on expert preferred practices and treatments. The system and method of the present invention can be provided as a stand alone service or adapted as a value added service to an existing pharmacy benefit management product.

By relying upon national standards such as the published Expert Consensus Guideline Series, a panels of experts, and training and management of continuing medical education (CME) events, the system and method of the present invention has the ability to identify clinical problems and initiate a highly credible series of educational interventions that are acceptable to prescribing physicians.

A first particular embodiment of the system and method of the present invention provides an analysis of data against ten quality metrics which are designed to highlight potential problems and opportunities for improving care. However, as would be obvious to those skilled in the art, additional or modified metrics can be introduced and adapted to analytical findings—thus a continuous quality improvement feature can be maintained.

In the system and method of the present invention data analysis is automated and a variety of useful reports can also be generated that identify opportunities for improvement at the health plan, practitioner and patient level. Additionally, the present invention provides expert review of these reports to help the health system tailor targeted and specific educational and managerial interventions to improve patient care.

In a particularly preferred embodiment of the present invention, analysis of a doctor's prescription practices can give rise to generation of one intervention information. In another particularly preferred embodiment of the present invention, analysis of a doctor's prescription practices can give rise to generation of two different intervention informations. In another particularly preferred embodiment of the present invention, analysis of a doctor's prescription practices can give rise to generation of three different intervention informations. In another particularly preferred embodiment of the present invention, analysis of a doctor's prescription practices can give rise to generation of four different intervention informations. In another particularly preferred embodiment of the present invention, analysis of a doctor's prescription practices can give rise to generation of five different intervention informations. In another particularly preferred embodiment of the present invention, analysis of a doctor's prescription practices can give rise to generation of six different intervention informations. In another particularly preferred embodiment of the present invention, analysis of a doctor's prescription practices can give rise to generation of seven different intervention informations. In another particularly preferred embodiment of the present invention, analysis of a doctor's prescription practices can give rise to generation of eight different intervention informations. In another particularly preferred embodiment of the present invention, analysis of a doctor's prescription practices can give rise to generation of nine different intervention informations. Finally, in another particularly preferred embodiment of the present invention, analysis of a doctor's prescription practices can give rise to generation of ten different intervention informations.

In a currently preferred embodiment of the present invention the intervention informations can be provided to doctors and health plan medical directors via: letters sent by mail, e-mail, direct computer-to-computer messaging, face-to-face personally, a personal telephone call, automated telephone messaging, and by facsimile. Intervention informations can also be provided by other forms of communication.

One preferred embodiment of the invention describes a method for providing an intervention information based solely on prescription data, said method comprising the steps of: providing a prescription data;

providing a reference guideline;

defining a comparative metric;

comparing said prescription data to said reference guideline on a basis of said metric;

computing a deviation of said metric as a difference between said prescription data and said reference guideline;

comparing said deviation to a threshold deviation; and

if said deviation exceeds said threshold deviation, providing said intervention information.

Another preferred embodiment of the invention described a computer system having a computer program set of instructions stored thereon that when executed can perform a method for providing an intervention information based solely on a pharmaceutical prescription, said system comprising:

a computer;

a first memory connected to said computer, said first memory having a computer program set of instructions for performing a method for reviewing and analyzing a pharmaceutical prescription stored thereon;

a second memory connected to said computer, said second memory having at least one pharmaceutical prescription record stored thereon; and

a third memory connected to said computer, said third memory having at least one expert guideline stored thereon.

Another preferred embodiment of the present invention describes a computer program for providing an intervention information based solely of data derived from a pharmaceutical prescription data, said computer program comprising a plurality of programed intervention informations outputs.

A further preferred embodiment of the invention describes an intervention information based solely on data derived from a pharmaceutical prescription data, said intervention information produced by a process of:

providing a prescription data;

providing a reference guideline;

defining a comparative metric;

comparing said prescription data to said reference guideline on a basis of said metric;

computing a deviation of said metric as a difference between said prescription data and said reference guideline;

comparing said deviation to a threshold deviation; and

if said deviation exceeds said threshold deviation, providing said intervention information.

Additionally, in another preferred embodiment of the present invention intervention informations can include citation to published expert studies, reports and guidelines. In a further preferred embodiment of the present invention the intervention informations can include, appended thereto, copies of cited or referenced published expert studies, reports and guidelines.

These and other objects, features and advantages of the invention will be better understood by those skilled in the art by reference to the following detailed description taken together with the following drawings in which like numerals identify like elements throughout the several views.

### BRIEF DESCRIPTION OF THE FIGURES

FIG. 1 is a schematic representation of a prior art network linking a patient's prescription through a pharmacy computer to a clearing house computer system.

FIG. 2 is a schematic representation of a computer system architecture of the present invention.

FIGS. 3a-3b are excerpts from an example of a prior art Expert Consensus Guideline for Medication Treatment of Bipolar Disorder.

FIGS. 4a-4b are excerpts from an example of a prior art Expert Consensus Guideline for Treatment of Agitation in Older Persons with Dementia.

FIG. 5 is an overview of a schematic flowchart of the analysis and intervention method of the present invention.

FIG. 6a is a schematic flowchart of the analysis and intervention method for therapeutic duplication of atypical anti-psychotics of FIG. 5.

FIG. 6b is an example of an intervention letter produced by the method of FIG. 6a.

FIG. 7a is a schematic flowchart of the analysis and intervention method for excess dosing of FIG. 5.

FIG. 7b is an example of an intervention letter produced by the method of FIG. 7a.

FIG. 8a is a schematic flowchart of the analysis and intervention method for inadequate dosing of FIG. 5.

FIG. 8b is an example of an intervention letter produced by the method of FIG. 8a.

FIG. 9a is a schematic flowchart of the analysis and intervention method for drug/drug interactions of FIG. 5.

FIG. 9b is an example of an intervention letter produced by the method of FIG. 9a.

FIG. 10a is a schematic flowchart of the analysis and intervention method for cost-ineffective pill strength selection of FIG. 5.

FIG. 10b is an example of an intervention letter produced by the method of FIG. 10a.

FIG. 11a is a schematic flowchart of the analysis and intervention method for multiple drugs in same chemical class of FIG. 5.

FIG. 11b is an example of an intervention letter produced by the method of FIG. 11a.

FIG. 12a is a schematic flowchart of the analysis and intervention method for patient adherence of FIG. 5.

FIG. 12b is an example of an intervention letter produced by the method of FIG. 12a.

FIG. 13a is a schematic flowchart of the analysis and intervention method for brand vs. generics of FIG. 5.

FIG. 13b is an example of an intervention letter produced by the method of FIG. 13a.

FIG. 14a is a schematic flowchart of the analysis and intervention method for a patient receiving prescriptions from multiple doctors of FIG. 5.

FIG. 14b is an example of an intervention letter produced by the method of FIG. 14a.

FIG. 15a is a schematic flowchart of the analysis and intervention method for long-term usage of FIG. 5.

FIG. 15b is an example of an intervention letter produced by the method of FIG. 15a.

### DETAILED DESCRIPTION

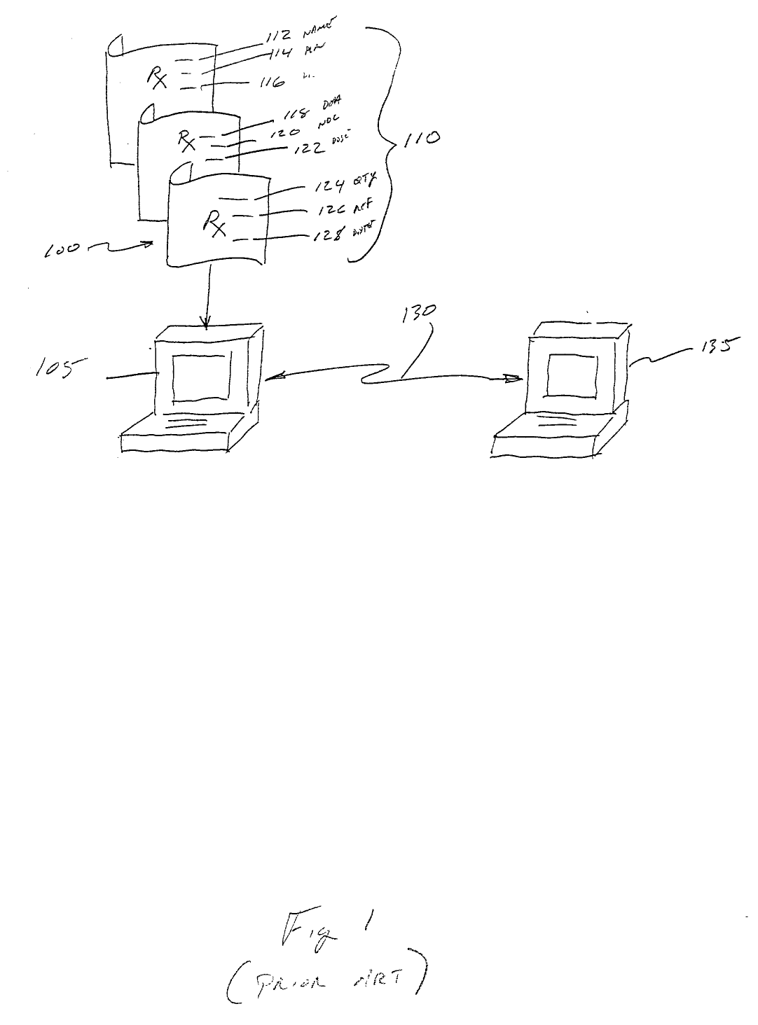

Referring to FIG. 1, a patient (not shown) belonging to a health benefit plan (not shown) such as a Health Maintenance Organization (HMO), a-Preferred Provider Plan (PPO), a traditional health insurance indemnity plan, a government subsidized medical benefit plan such as Medicare, or another type of health benefit plan presents, in a conventional manner, a prescription 100 to a pharmacy (not shown) to be filled in accordance with a doctor's instructions written thereon. A pharmacist (not shown) enters data 110 from prescription 100 into pharmacy computer 105 in a conventional manner. Data 110 comprises patient name 112, benefit plan registration number 114, physician name 116, Drug Enforcement Agency (DEA) number 118, drug code (NDC) 120, dosage 122, dispensing quantity 124, number of prescribed refills 126, prescription date 128, administration instructions, and other relevant data (not shown).

Pharmacy computer 105 is connected in a conventional manner by communications link 130 to a clearing house computer 135. Clearing house computer can be integral with pharmacy computer 105 or can be located remote therefrom. Computer 105 transmits data 110 to computer 135 across communications link 130. Based on benefit plan registration number 114, computer 135 validates in a conventional manner the patient's participation in the health benefit plan. If validated, computer 135 returns, in a conventional manner as is known in the art, an authorization data (not shown) and a patient co-payment amount (not shown) to computer 105 via link 130. The pharmacy then fills prescription 100 in a conventional manner at which time the prescribed drug can be dispensed to the patient and the patient's co-payment amount, if any, can be collected from the patient. Computer 135 can also return other data to computer 105 such as: invalid patient identification (not shown), patient's health plan participation expired (not shown), reimbursement amount to be paid to the pharmacy by the health plan (not shown), warning information to be provided to the patient (not shown), and other data.

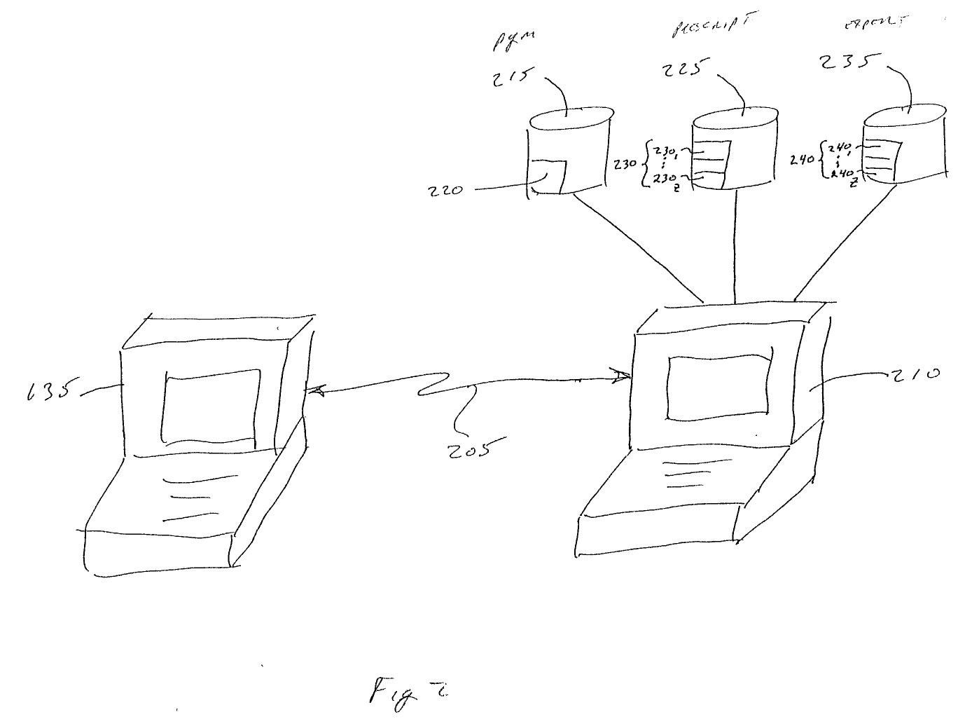

Referring now to FIG. 2, computer 135 is connected by a communications link 205 to a monitoring/analysis computer 210 having a processor and at least one memory connected thereto. Monitoring computer 210 can be the same computer as pharmacy computer 105, clearing house computer 135, a separate health benefits plan's computer, or a separate third-party monitoring service's computer. A first memory 215 having analysis program 220 of the present invention stored thereon is connected to computer 210. A second memory 225 is also connected to computer 210. Memory 225 has a prescription history database 230 stored thereon. Prescription history database 230 has a plurality of prescription records 230₁ . . . 230ᵢ . . . 230_{z} stored therein. For each prescription 100 submitted and filled by a pharmacy for a patient participating in a health plan, computer 135 transmits prescription data 110 to monitoring computer 210. Monitoring computer 210 stores prescription data 110 corresponding to prescription 100 in prescription history data base 230 as prescription record 230ₙ.

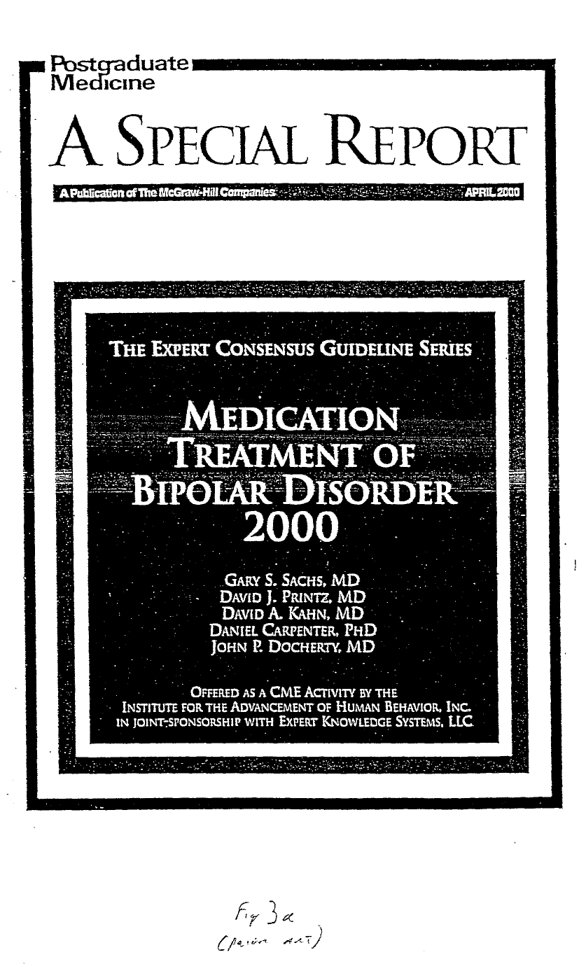

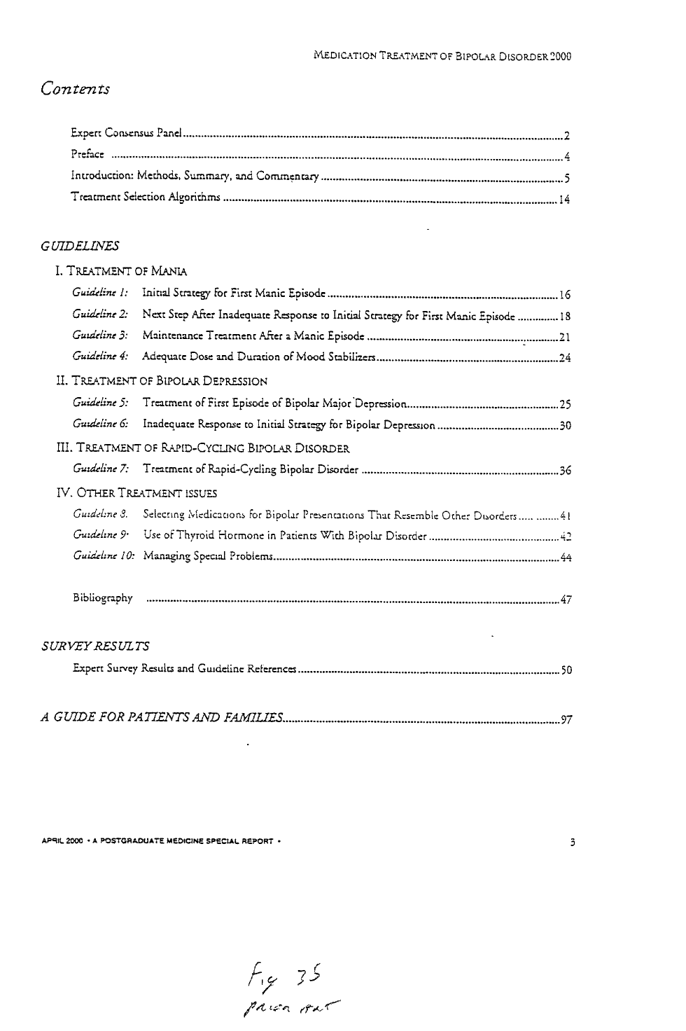

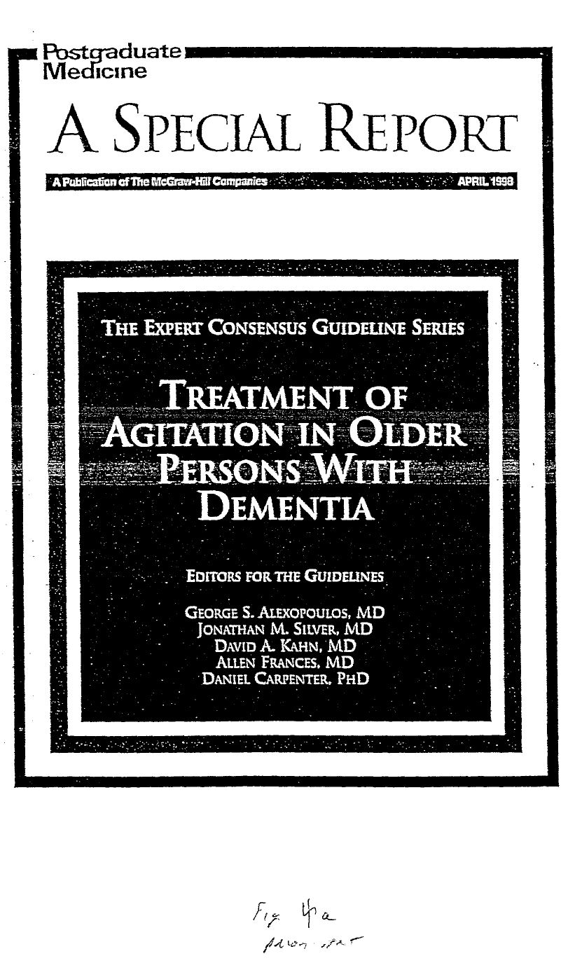

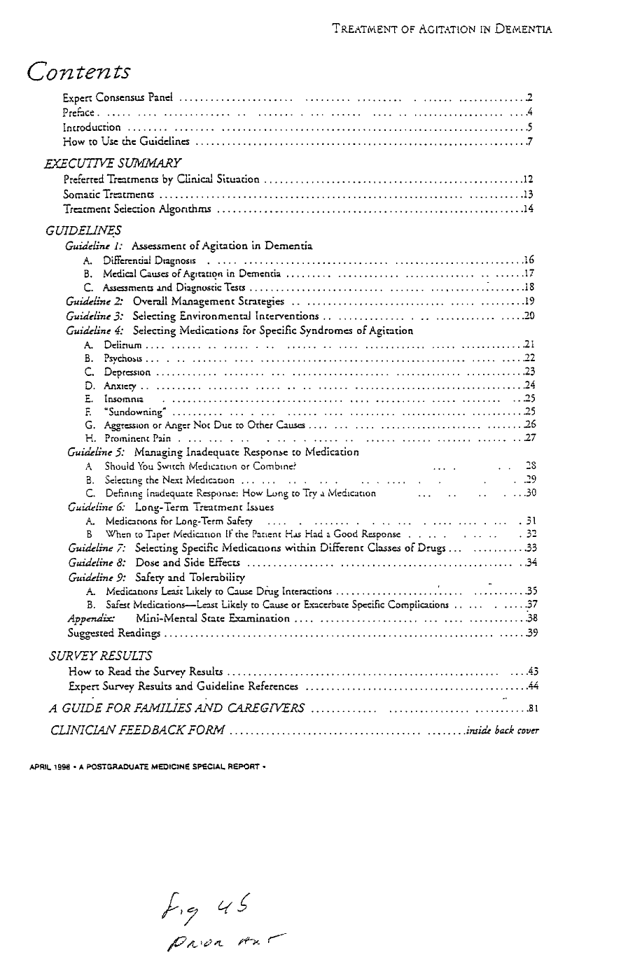

A third memory 235 is also connected to computer 210. Memories 215, 225 and 235 can be the same physical memory device or can be separate physical memory devices. Memory 235 has an expert consensus guidelines database 240 stored thereon. Guidelines database 240 has a plurality of expert guidelines records 240₁ . . . 240₁ . . . 240_{z} stored therein in a computer readable form. FIGS. 3a-3b show an exemplary hardcopy version of a particular expert consensus guideline for medication treatment of bipolar disorder, such as can be stored in one of the plurality of expert guidelines records, such as record 240ⱼ; and FIGS. 4a-4b show another exemplary hardcopy version of a particular expert consensus guideline for treatment of agitation in older persons with dementia, such as can be stored in another of the plurality of expert guidelines records, such as record 240ₖ. Other expert consensus guidelines (not shown) for other diseases, conditions and drugs can be similarly stored in other of the plurality of expert guidelines records of expert guidelines database 240.

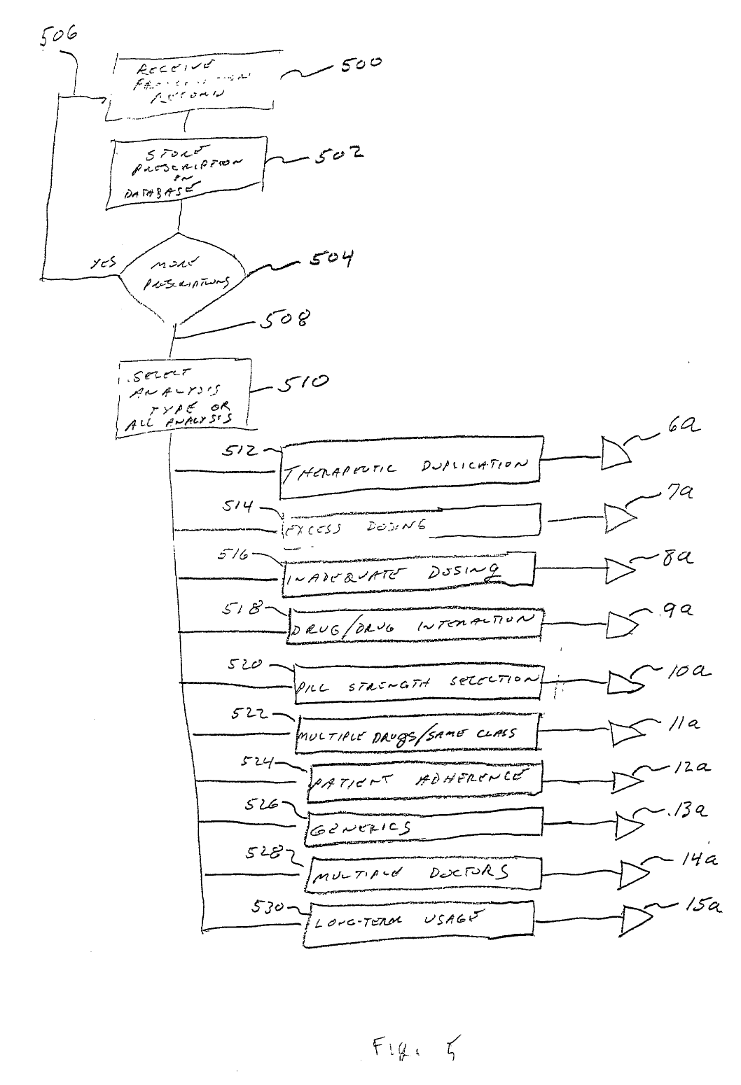

Referring to FIG. 5, a flowchart of a computerized analysis and intervention program 220 of the method of the present invention is shown. Program 200 is loaded into and executed in the processor of computer 210. A conventional database management program 500 also runs on computer 210 in a background which receives prescription records from computer 135 and stores them into database 240 as records 240₁ . . . 240_{z} by process 502. Decision box 504 determines if additional prescription records are to be stored. If additional prescriptions are to be stored control returns to process 500 via link 506. If no further prescriptions are to be stored, control passes via link 508 to process 510 where an analysis type of the present invention is selected. The analysis selection can be either manually initiated, or computer initiated based, for example, on a schedule analysis cycle, or some other criteria such as a particular patient or doctor or a particularized period of time. A single type analysis (such as shown in any of blocks 512-530) or multiple analyses (encompassing more than one of blocks 512-530) can be selected.

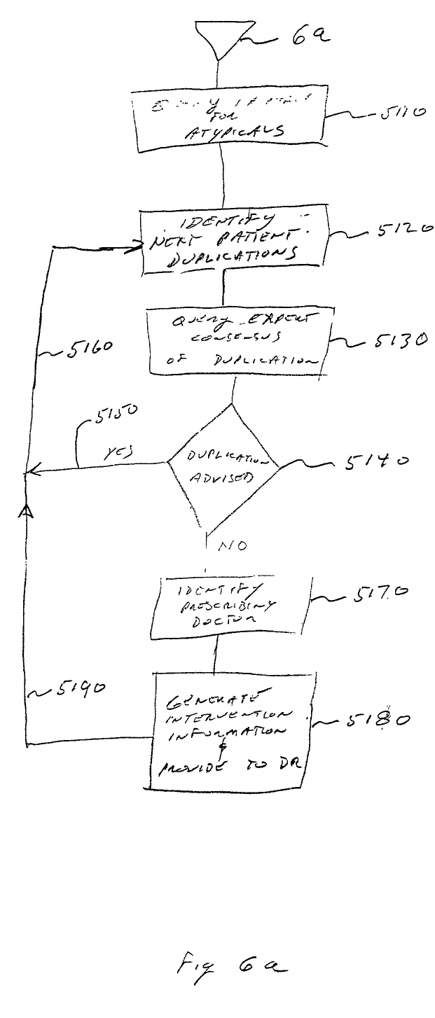

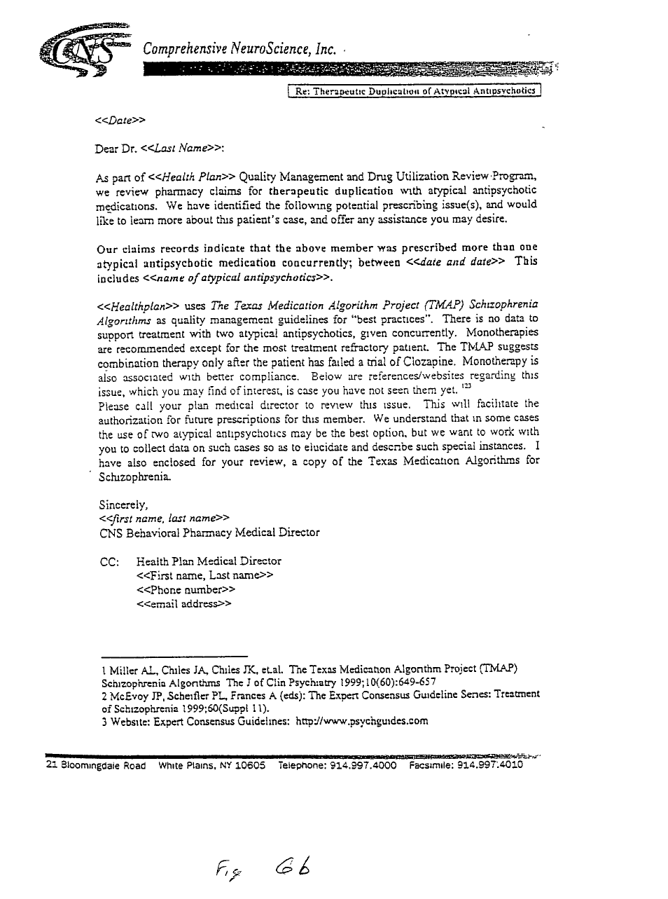

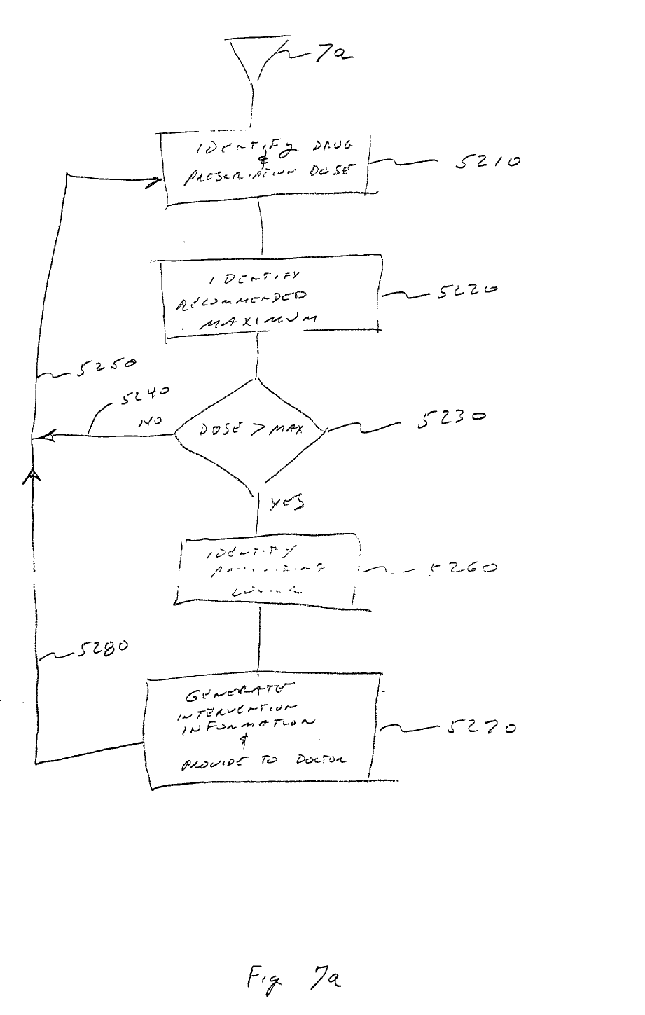

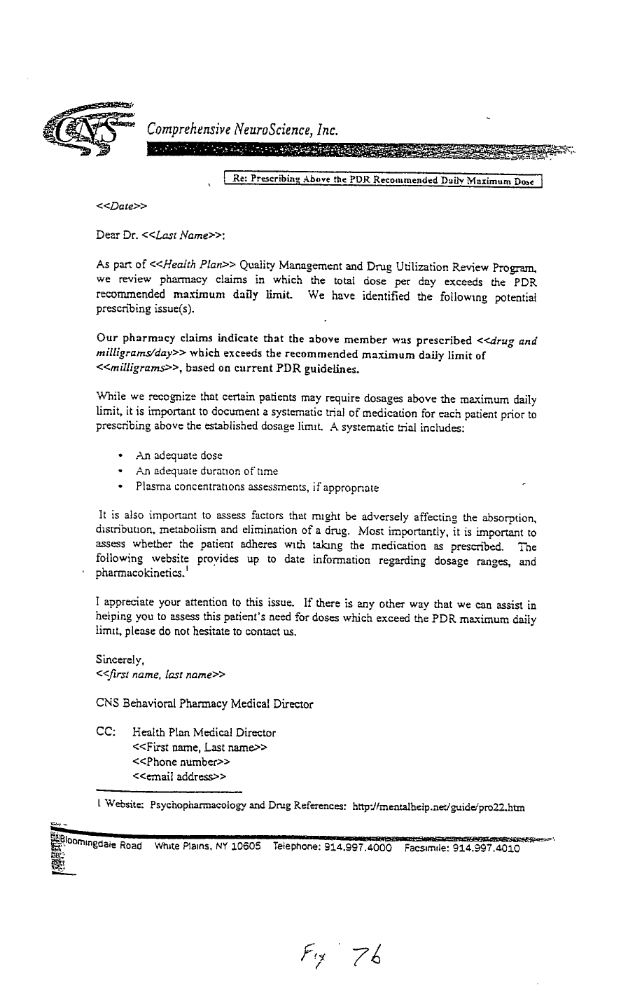

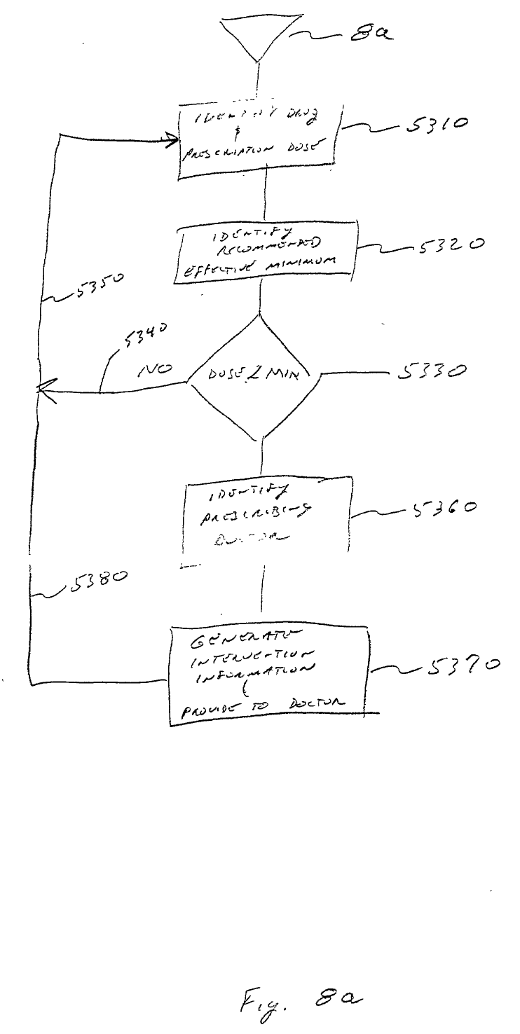

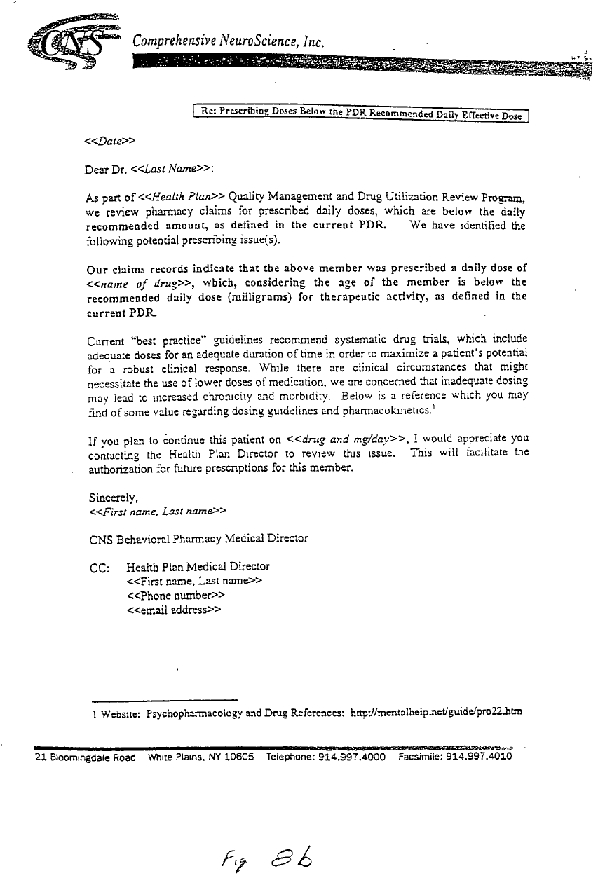

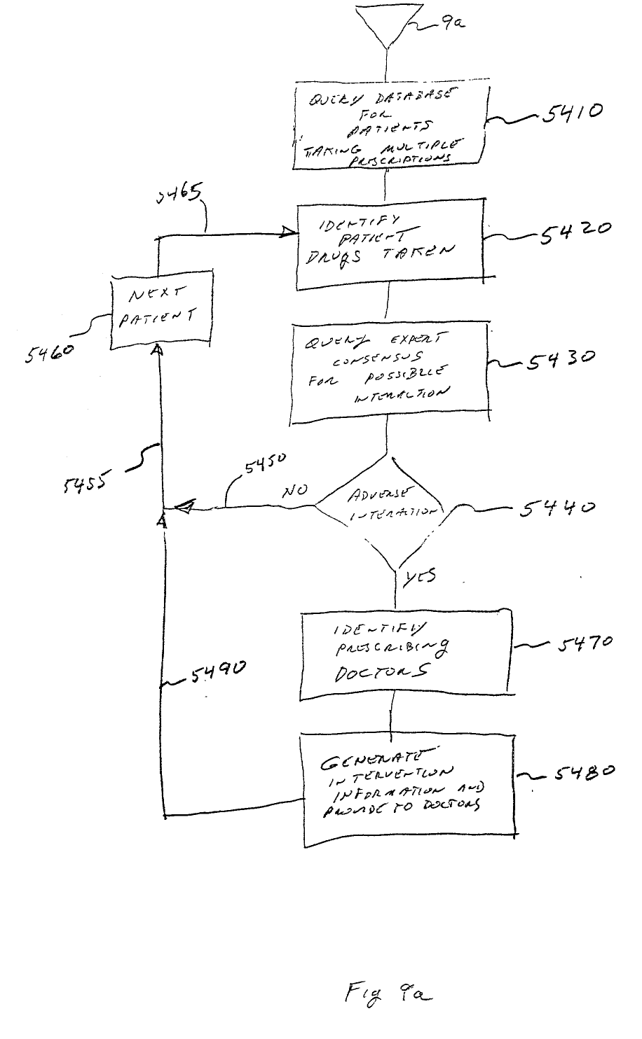

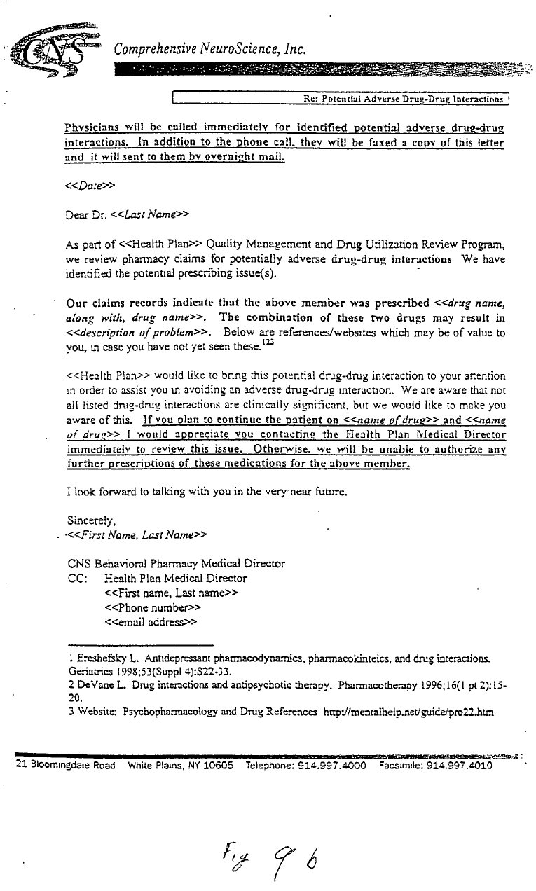

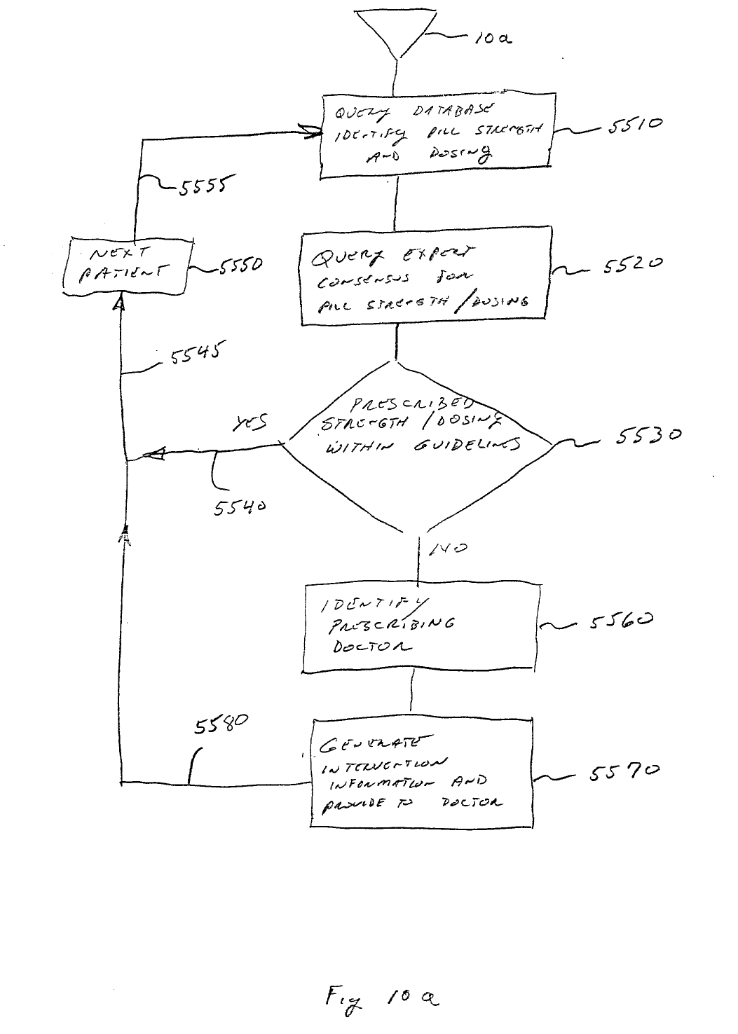

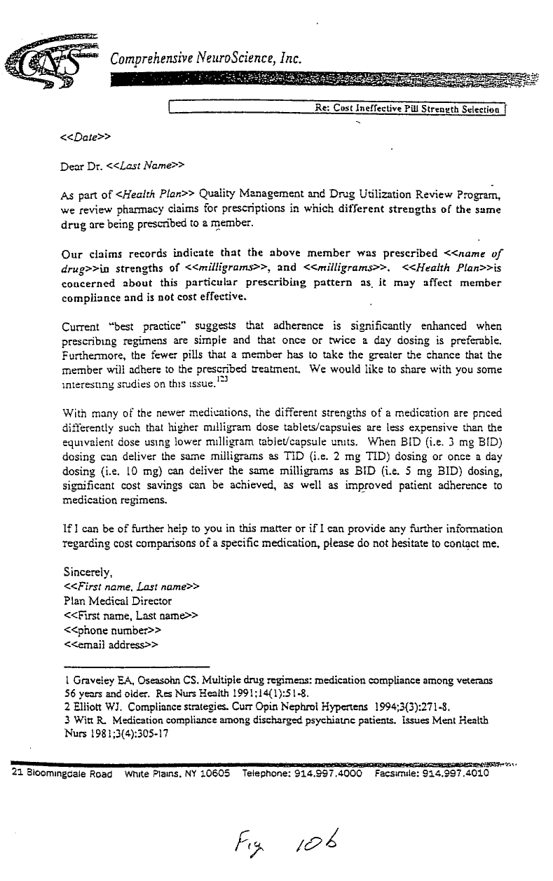

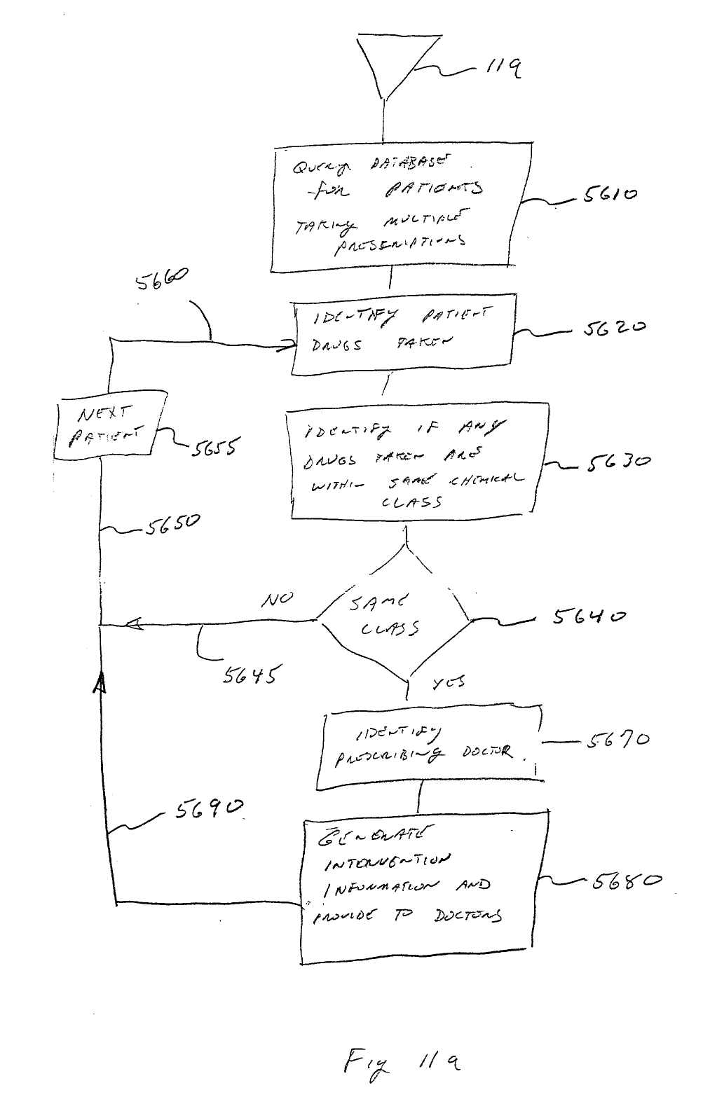

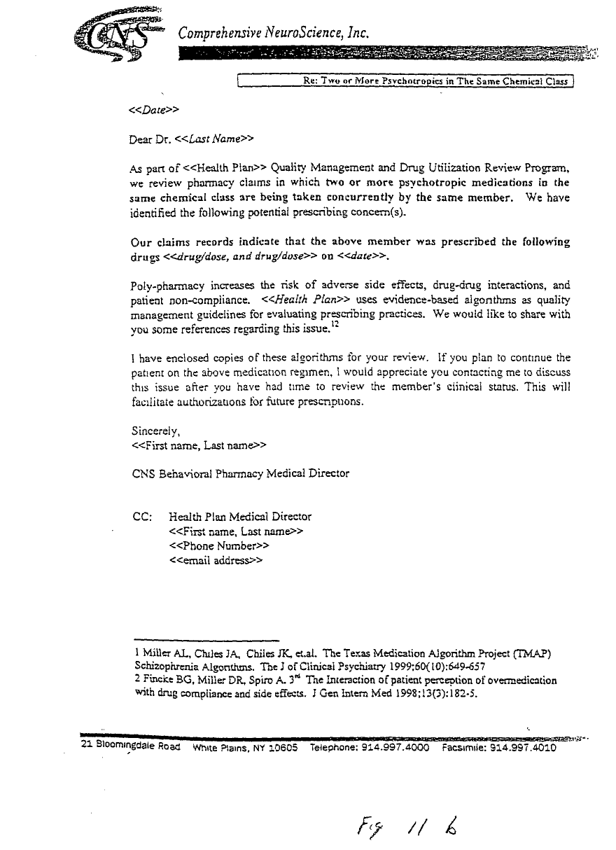

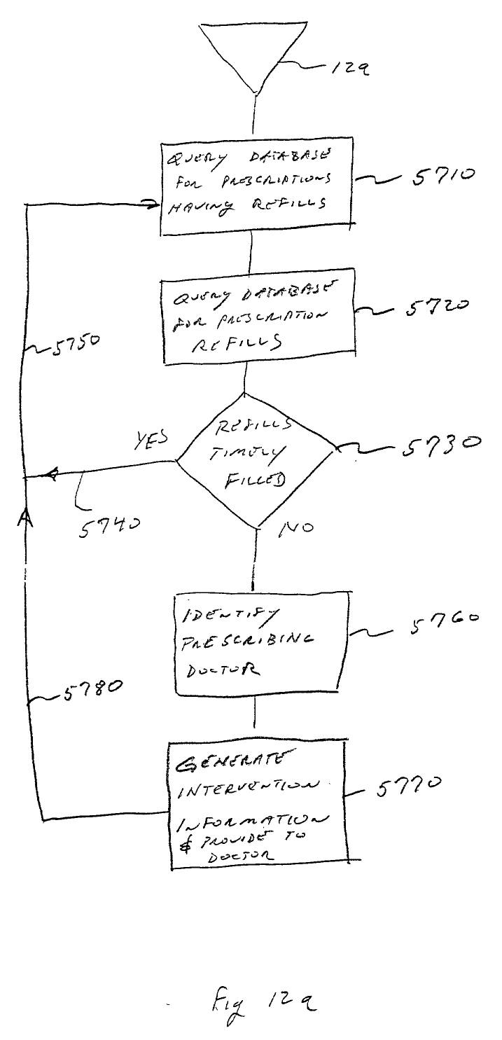

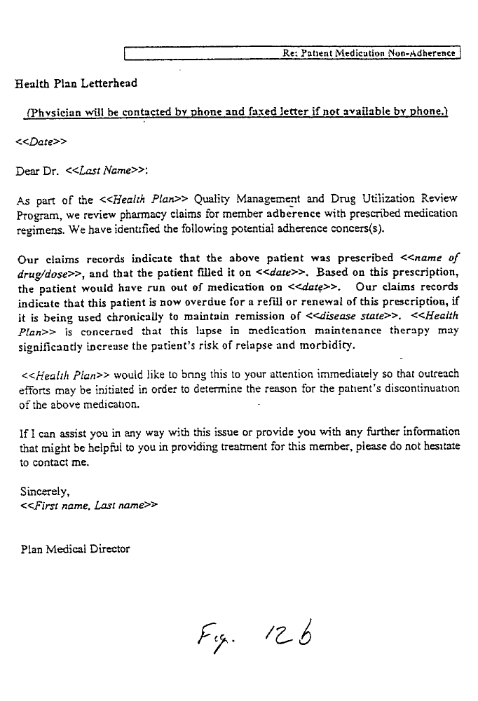

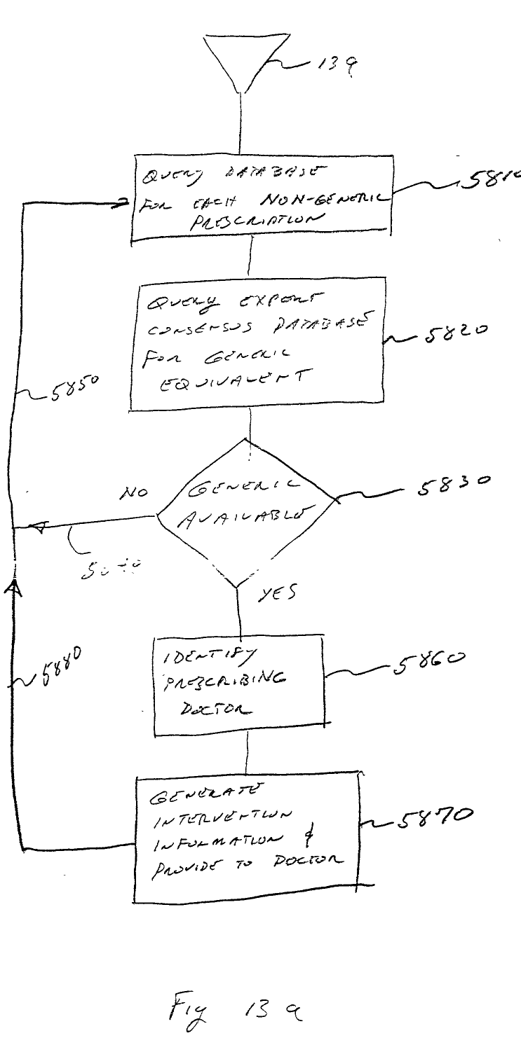

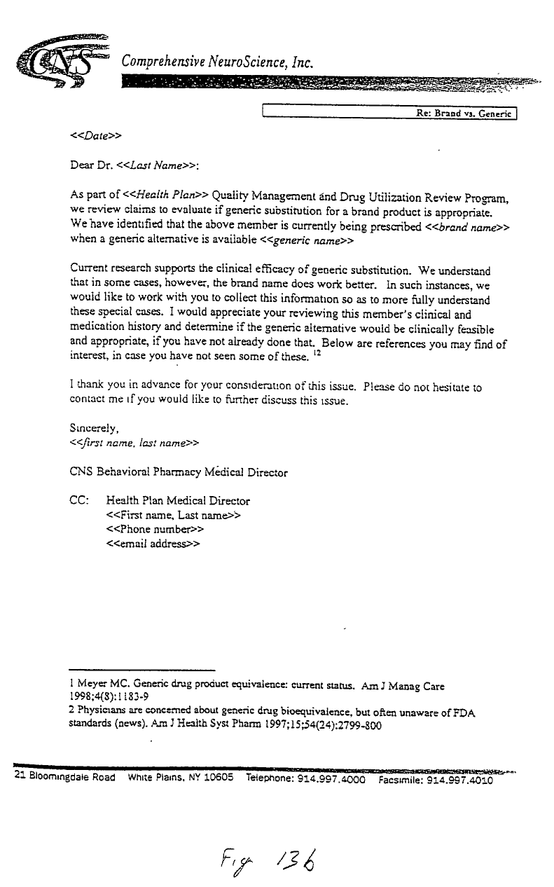

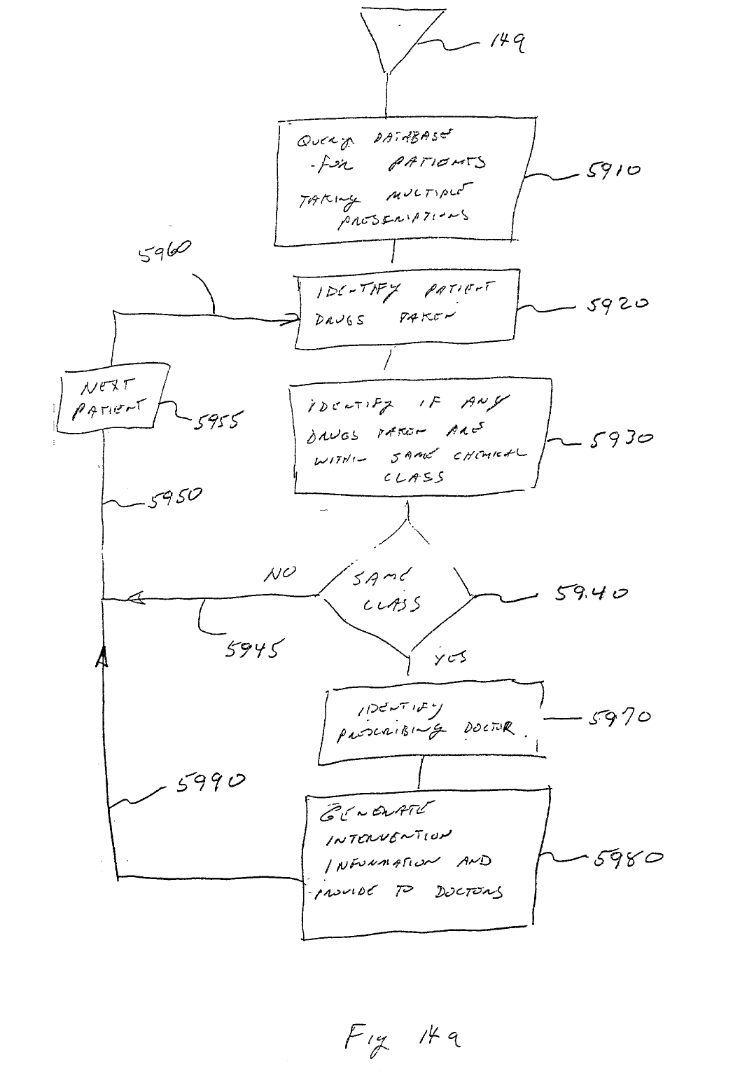

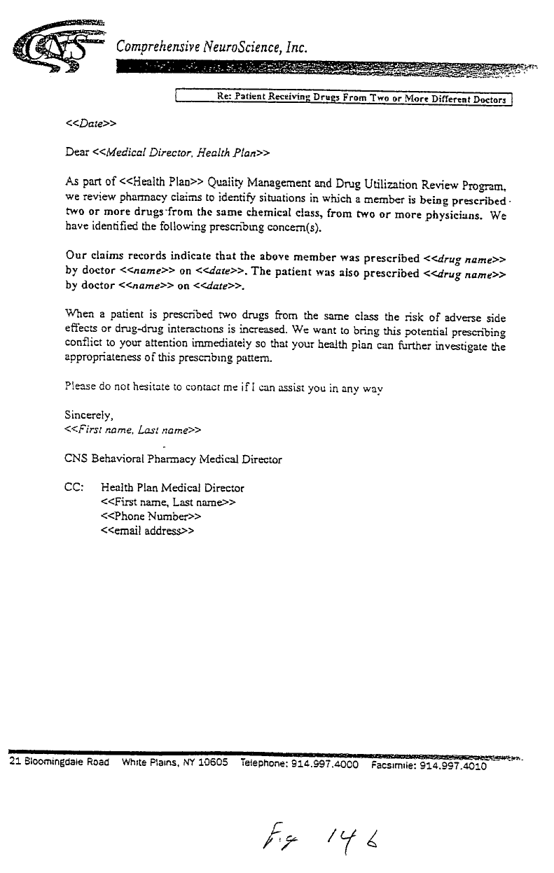

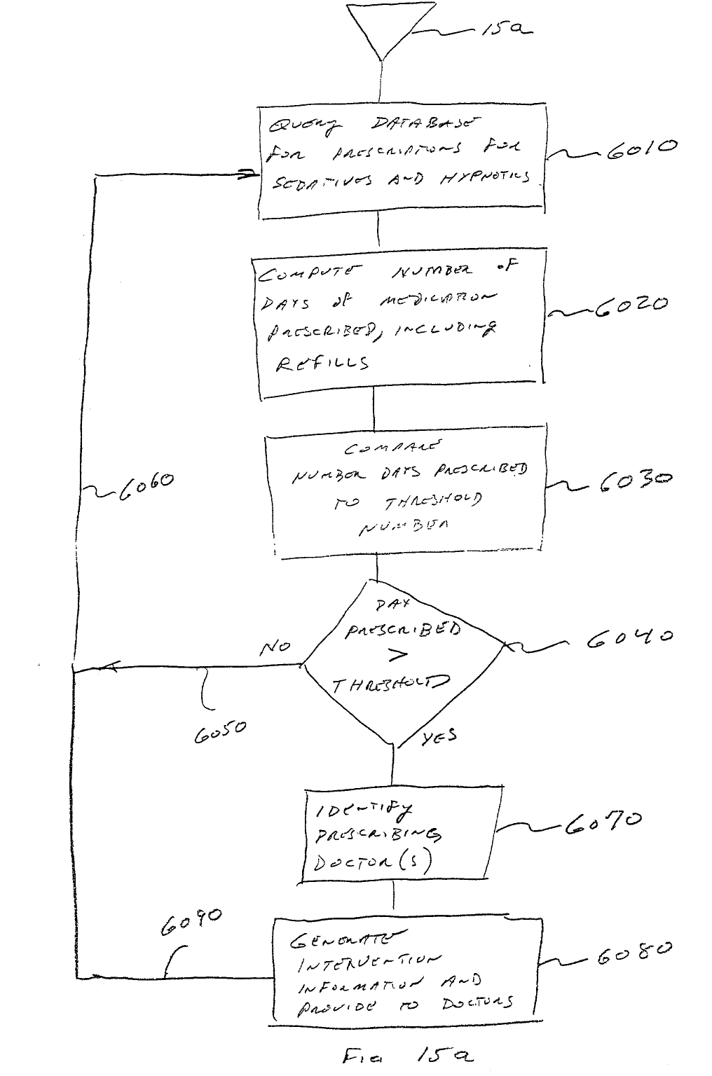

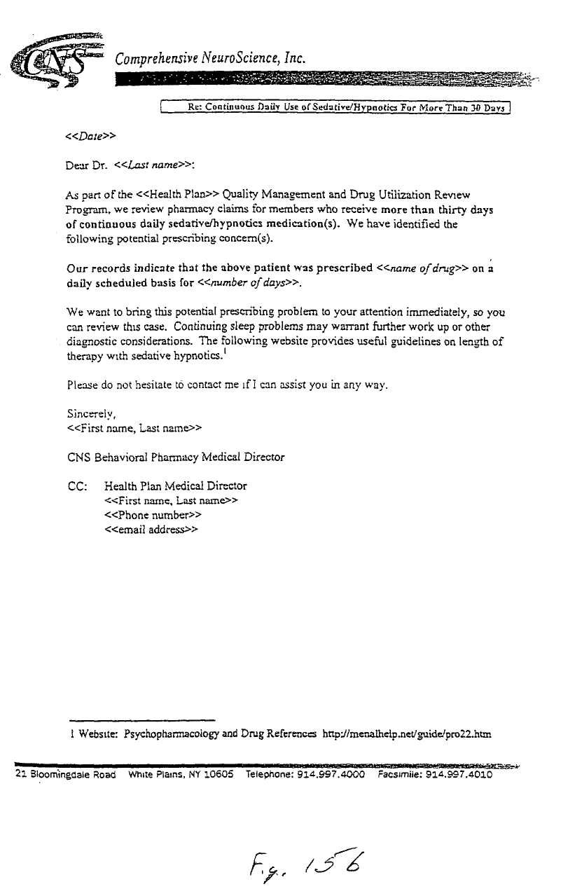

In a currently preferred embodiment of the present invention directed to psychotropic drugs, one or more of ten different analysis types can be selected. When a therapeutic duplication analysis is run, program 200 advances to process 512 as more particularly described in FIG. 6a. When an excess dosing analysis is run, program 200 advances to process 514 as more particularly described in FIG. 7a. When a inadequate dosing analysis is run, program 200 advances to process 516 as more particularly described in FIG. 8a. When a drug/drug interaction analysis is run, program 200 advances to process 518 as more particularly described in FIG. 9a. When a pill strength selection analysis is run, program 200 advances to process 520 as more particularly described in FIG. 10a. When a multiple drugs/same class analysis is run, program 200 advances to process 522 as more particularly described in FIG. 11a. When a patient adherence analysis is run, program 200 advances to process 524 as more particularly described in FIG. 12a. When a generics analysis is run, program 200 advances to process 526 as more particularly described in FIG. 13a. When a multiple doctors analysis is run, program 200 advances to process 528 as more particularly described in FIG. 14a; and when a long term usage analysis is run, program 200 advances to process 530 as more particularly described in FIG. 15a.

With reference to FIG. 6a, step 5110 of program 220 performs a query of database 230 to identify all prescription records 230ⱼ where atypical antipsychotics (as determined by NDC 120) have been prescribed. In step 5120 the records 230ⱼ of the prescribed atypical antipsychotics are further queried to identify those specific patients (as determined by benefit plan registration number 114) who have been prescribed multiple atypical antipsychotics and a particular combination of atypicals that have been prescribed to them. For each patient having a combination of prescribed atypicals, process 5130 queries expert consensus database 240 to find any applicable expert consensus record 240ⱼ regarding the particular combination of atypicals prescribed to that patient. If an expert consensus record 240ₖ supports the duplication, decision block 5140 returns program 220 via links 5150 and 5160 to step 5120 for a next patient having an atypical duplication. If the duplication is advised against by expert consensus record 240ₖ, program 220 identifies the doctor(s) 116 prescribing the atypicals to the patient, and in step 5180 initiates creation and furnishing of an intervention information, such as shown in FIG. 6b in the form of a letter with citations to reference publications, that is provided to the prescribing doctor(s). Program 220 then returns via links 5190 and 5160 to step 5120 to repeat the analysis for a next patient.

With reference to FIG. 7a, step 5210 of program 220 performs a query of database 230 to identify all prescription records 230ⱼ with their corresponding prescribed drug (as determined by NDC 120) and dosage 122. For each prescription record 230ⱼ step 5220 queries expert consensus database 240 to find any applicable expert consensus record 240ⱼ which defines the recommended daily maximum dosage (not shown). If the prescribed dosage 122 does not exceed a recommended maximum dosage, decision block 5230 returns program 220 via links 5240 and 5250 to step 5210 for a next prescription record 230ⱼ₊₁. If the prescribed dosage 122 exceeds the maximum recommended daily dosage, step 5260 of program 220 identifies the doctor(s) 116 prescribing the high dosage to the patient, and in step 5270 initiates creation and furnishing of an intervention information, such as shown in FIG. 7b in the form of a letter with citations to reference publications, that is provided to the prescribing doctor(s). Program 220 then returns via links 5280 and 5250 to step 5210 to repeat the analysis for a next prescription.

With reference to FIG. 8a, step 5310 of program 220 performs a query of database 230 to identify all prescription records 230ⱼ with their corresponding prescribed drug (as determined by NDC 120) and dosage 122. Step 5310 can be the same step as step 5210 as shown in FIG. 7a. For each prescription record 230j step 5320 queries expert consensus database 240 to find any applicable expert consensus record 240ⱼ which defines the recommended daily minimum effective dosage (not shown). Step 5320 can be performed concurrent with step 5220 as shown in FIG. 7a. If the prescribed dosage 122 is not less than a recommended minimum effective dosage, decision block 5330 returns program 220 via links 5340 and 5350 to step 5310 for a next prescription record 230ⱼ₊₁. If the prescribed dosage 122 is less than a recommended minimum effective daily dosage, step 5360 of program 220 identifies the doctor(s) 116 prescribing the low dosage to the patient, and in step 5370 initiates creation and furnishing of an intervention information, such as shown in FIG. 8b in the form of a letter with citations to reference publications, that is provided to the prescribing doctor(s). Program 220 then returns via links 5380 and 5350 to step 5310 to repeat the analysis for a next prescription.

With reference to FIG. 9a, step 5410 of program 220 performs a query of database 230 to identify all patients taking multiple prescriptions. For each patient taking multiple prescriptions, step 5420 identifies that patient's prescription records 230ⱼ . . . 230ₘ to determine all of the prescribed drugs (as determined by NDC 120) taken by the patient. At step 5430 expert consensus database 240 is queried to find any applicable expert consensus record 240ⱼ which defines if any combination of the drugs taken by the patient can potentially result in an adverse reaction or is otherwise contraindicated. If none of the combinations of drugs results in an adverse reaction or is otherwise contraindicated, decision block 5440 returns program 220 via links 5450 and 5455 to step 5460 where a next patient is identified and then returns program 220 to step 5420. If in decision step 5440 a combination of drugs taken by the patient is identified as potentially giving rise to an adverse reaction or is otherwise contraindicated, program 220 advances to step 5470 which identifies the doctor(s) 116 prescribing the potentially interacting drugs to the patient. Program 220 then advances to step 5480 which initiates creation and furnishing of an intervention information, such as shown in FIG. 9b in the form of a letter with citations to reference publications, that is provided to the prescribing doctor(s). Additionally, due to the urgency of the potential interaction, an immediate contact with the prescribing doctor(s) is initiated by telephone, facsimile, direct computer-to-computer communication, e-mail, or otherwise. Program 220 then returns via links 5490 and 5455 to step 5460 which advances program 220 to a next patient and then returns via link 5465 to step 5420 to repeat the analysis for that next patient.

With reference to FIG. 10a, step 5510 of program 220 performs a query of database 230 to identify, for each patient prescription record 230ⱼ, a pill strength (as determined by NDC 120) and dosing 122. At step 5520 expert consensus database 240 is similarly queried to find any applicable expert consensus record 240, which defines a recommended combination of pill strength and dosing. If the prescribed combination of pill strength and dosing fall within a range of recommended combinations of pill strength and dosing, decision block 5530 returns program 220 via links 5540 and 5545 to step 5550 where a next patient is identified and then returns program 220 to step 5510. If decision step 5530 determines that the combination of prescribed pill strength and dosing fall outside the recommended range of combinations of pill strength and dosing, program 220 advances to step 5560 which identifies the doctor(s) 116 prescribing the non-recommended combination of pill strength and dosing. Program 220 then advances to step 5570 which initiates creation and furnishing of an intervention information, such as shown in FIG. 10b in the form of a letter with citations to reference publications, that is provided to the prescribing doctor(s). Program 220 then returns via links 5580 and 5545 to step 5550 which advances program 220 to a next patient and then returns via link 5555 to step 5510 to repeat the analysis for that next patient.

With reference to FIG. 11a, step 5610 of program 220 performs a query of database 230 to identify all patients taking multiple prescriptions prescribed by the same doctor 116. Step 5610 is similar to step 5410 previously described with respect to FIG. 9a and can be simultaneously performed. For each patient taking multiple prescriptions, step 5620 identifies that patient's prescription records 230ⱼ . . . 230ₘ to determine all of the prescribed drugs (as determined by NDC 120) taken by the patient. Step 5620 is similarly analogous to step 5420 previously described with respect to FIG. 9a and can likewise be simultaneously performed. At step 5630 expert consensus database 240 is queried to find any applicable expert consensus record 240ⱼ which, for the respective patient, defines if any combination of the drugs identified in step 5620 belong to a same chemical class. If none of the combinations of drugs belong to the same chemical class, decision block 5640 returns program 220 via links 5645 and 5650 to step 5655 where a next patient is identified and then returns program 220 to step 5620. If in decision step 5640 a combination of drugs taken by the patient is identified as belonging to the same chemical class, program 220 advances to step 5670 which identifies the doctor 116 prescribing the drugs of the combination belonging to the same class. Program 220 then advances to step 5680 which initiates creation and furnishing of an intervention information, such as shown in FIG. 11b in the form of a letter with citations to reference publications, that is provided to the prescribing doctor. Program 220 then returns via links 5690 and 5650 to step 5655 which advances program 220 to a next patient and then returns via link 5660 to step 5620 to repeat the analysis for that next patient.

With reference to FIG. 12a, step 5710 of program 220 performs a query of database 230 to identify, for each patient prescription record 230ⱼ, if refills 126 are permitted. For each prescription record 230ⱼ identified in step 5710, step 5720 identifies any additional prescription records 230ⱼ₊₁, for the same drug 120 and dose 122 having a date 128 subsequent to the date 128 of a first occurring prescription record 230ⱼ identified in step 5710. At decision block 5730 the timeliness of the respective prescription refills is determined by comparing the respective dates 128 of the refills to expected dates (not shown) on which the prescription should theoretically have been refilled based on a quantity 124 prescribed and a dosing 122. If the prescription refill was timely filled, step 5730 returns program 220 via links 5740 and 5750 to step 5710 to repeat the analysis for another prescription record 230ⱼ₊ₓ. If decision block 5730 determines that the prescription was either not timely refilled or was not refilled at all, program 220 advances to step 5760 which identifies the doctor(s) 116 prescribing the non-refilled drug. Program 220 then advances to step 5770 which initiates creation and furnishing of an intervention information, such as shown in FIG. 12b in the form of a letter, which can include citations to reference publications, that is provided to the prescribing doctor(s). Program 220 then returns via links 5780 and 5750 to step 5710 to repeat the analysis for that next prescription.

With reference to FIG. 13a, step 5810 of program 220 performs a query of database 230 to identify each prescription record 230j, which prescribed a non-generic drug (as determined by NDC 120).

For each prescription record 230ⱼ identified in step 5810, step 5820 queries expert consensus guidelines database 240 to find any applicable expert consensus record 240ⱼ which defines if a generic equivalent of the prescribed drug is available. If a generic equivalent is not available, decision block 5830 returns program 220 via links 5840 and 5850 to step 5810 to repeat the analysis for another non-generic prescription record 230ⱼ₊₁. If decision block 5830 determines that a generic equivalent for the drug is available, program 220 advances to step 5860 which identifies the doctor(s) 116 prescribing the non-generic drug. Program 220 then advances to step 5870 which initiates creation and furnishing of an intervention information, such as shown in FIG. 13b in the form of a letter, which can include citations to reference publications, that is provided to the prescribing doctor(s). Program 220 then returns via links 5880 and 5850 to step 58710 to repeat the analysis for that next non-generic prescription.

With reference to FIG. 14a, the method of FIG. 14a is similar to the method of FIG. 11a with the exception that FIG. 11a describes the situation of multiple prescriptions for drugs in the same chemical class with both drugs being prescribed to a patient by a singular doctor. FIG. 14a similarly addresses multiple prescriptions for drugs in the same chemical class. However, in FIG. 14a, the drugs in the same chemical class that are prescribed to a patient are prescribed by two or more different doctors.

At step 5910 program 220 performs a query of database 230 to identify all patients taking prescriptions prescribed by different doctors 116. For each patient taking prescriptions from multiple doctors, step 5920 identifies that patient's prescription records 230ⱼ . . . 230ₘ to determine all of the prescribed drugs (as determined by NDC 120) taken by that patient. At step 5930 expert consensus database 240 is queried to find any applicable expert consensus record 240ⱼ which, for the respective patient, defines if any combination of the drugs identified in step 5920 belong to a same chemical class. If none of the combinations of drugs belong to the same chemical class, decision block 5940 returns program 220 via links 5945 and 5950 to step 5955 where a next patient is identified and then returns program 220 to step 5920. If in decision step 5940 a combination of drugs taken by the patient is identified as belonging to the same chemical class, program 220 advances to step 5970 which identifies the individual doctors 116 of the multiple doctors prescribing the drugs of the combination belonging to the same class. Program 220 then advances to step 5980 which initiates creation and furnishing of an intervention information, such as shown in FIG. 14b in the form of a letter with citations to reference publications, that is provided to the health plan medical director and can be provided to each of the prescribing doctors. Program 220 then returns via links 5990 and 5950 to step 5955 which advances program 220 to a next patient and then returns via link 5960 to step 5920 to repeat the analysis for that next patient.

With reference to FIG. 15a, step 6010 of program 220 performs a query of database 230 to identify all prescription records 230ⱼ for a desired class of drugs such as sedatives and hypnotics (as determined by NDC 120). For each prescription record 230ⱼ, together with its allowed refills 126, step 6020 determines the number of days of medication prescribed. At step 6030 expert consensus database 240 can queried to find any applicable expert consensus record 240ⱼ which, for the respective prescription, defines a recommended maximum number of days of medication. Alternatively, a user defined threshold maximum number of days of medication can be provided. Decision block 6040 compares the recommended maximum number of days of medication with the number of days of medication actually prescribed. If the number of days of medication prescribed does not exceed the recommended maximum threshold, decision block 6040 returns program 220 via links 6050 and 6060 to step 6010. If in decision step 6040 the number of days of medication prescribed exceeds the recommended maximum threshold, program 220 advances to step 6070 which identifies the doctor(s) 116 prescribing the drugs. Program 220 then advances to step 6080 which initiates creation and furnishing of an intervention information, such as shown in FIG. 15b in the form of a letter which can include citations to reference publications, that is provided to the doctor. Program 220 then returns via links 6090 and 6060 to step 6010 to repeat the analysis for that next prescription.

In addition to the particularized analyses described above with reference to FIGS. 5 and 6a/b-15a/b, additional summary reports which, by way of example and not by way of limitation, can be provided to a health plan medical director which report: doctors writing a disproportionately high number of prescriptions and doctors whose prescriptions are disproportionately high in cost.

Also, although the system and method of the present invention have been described above with respect to a particular embodiment directed to psychotropic drugs, the system and method of the present invention are also useful for other types of drugs and disease states for which the above described intervention informations can be modified to correspond to the context of the particularized application. Examples of such other drugs and disease states follow:

### OTHER EXAMPLES

### Example I.

### Alzheimer' Disease Management

B. Cholinesterase Inhibitors

1. Donepezil HCL (Aricept)

2. Tacrine (Cognex)

3. Rivastigmine (Exelon)

C. Gama Secretase Inhibitors

1. None marketed now (in development)

Exemplary Quality Audits/Quality Letters:

Therapeutic duplication of cholinesterase inhibitors;

Excess Dosing;

Inadequate dosing;

Dosing Initiation and Titration;

Timing of the Dosages and Administration Instructions;

Drug/drug interaction;

Cost ineffective pill strength selection;

No timely refill (patient adherence);

Patient with two or more physicians.

### Example II.

### Analgesics

A. Acetaminophen and Combinations

1. Excedrin Migraine products

2. Tylenol products

B. Centrally Acting

1. Ultram (tramadol)

2. Duraclon (clonidine HCL injection)

C. Narcotic Analgesics (Agonist-Antagonist & Combinations) Controlled Substances

1. Buprenex Injectable (buprenorphine)

2. Nubain Injection (nalbuphine)

3. Stadol NS (butorphanol)

4. Talacen (pentazocine/acetaminophen)

5. Talwin Nx (pentazocine/naloxone)

6. Talwin compound (pentazocine/aspirin)

D. Narcotics and Combinations: Controlled Substances

1. Actiq (fentanyl)

2. Astramorph/PF injection (morphine sulfate injection)

3. Darvocet (propoxyphene napsylate/acetaminophen)

4. Darvon (propoxyphene hydrochloride)

5. Demerol (meperidine)

6. Dilaudid (hydromorphone)

7. Duragesic Transdermal System (fentanyl)

8. Duramorph injection (morphine sulfate injection)

9. Infumorph 200/500 (morphine sulfate preservative-free)

10. Kadian capsules (morphine sulfate sustained release)

11. Levo-Dromoran tablets/injectable (levorphanol)

12. Lortab (hydrocodone bitartrate/acetaminophen combo)

13. Mepergan Injection (meperidine HCL/promethazine)

14. MS Contin (morphine sulfate controlled-release)

15. MSIR tabs/caps/solution (immediate release morphine sulfate)

16. Norco Tablets (hydrocodone bitartrate/acetaminophen)

17. Numorphan suppositories/injection (Oxymorphone HCL)

18. Oramorph SR (morphine sulfate sustained release tablets)

19. Orlaam Oral Solution (levomethadyl acetate HCL)

20. OxyContin (Oxycodone HCL controlled-release tablets)

21. OxyFast (oxycodone HCL immediate release concentrate solution)

22. OxyIR (oxycodone HCL immediate-release capsules)

23. Percocet (oxycodone/acetaminophen)

24. Percodan (oxycodone/aspirin)

25. Percolone (oxycodone)

26. Roxanol (morphine sulfate immediate-release solution concentrate)

27. Tylenol with codeine (codeine/acetaminophen)

28. Tylox (oxycodone/acetaminophen)

29. Vicodin (hydrocodone bitartrate/acetaminophen)

30. Vicoprofen (hydrocodone/ibuprofen)

31. Wygesic (propoxyphene HCL/acetaminophen)

32. Zydone (hydrocodone bitartrate/acetaminophen)

E. Nonsteroidal Anti-Inflammatory Agents (NSAIDS)(COX-2's)

1. Anaprox (naproxen sodium)

2. Arthrotec (diclofenac/misoprostol)

3. Cataflam/Voltaren/Voltaren XR (diclofenac

4. Celebrex (celecoxib)

5. Clinoril (Sulindac)

6. Daypro (oxaprozin)

7. Disalcid (salsalate)

8. Dolobid (Diflunidal)

9. EC-Naprosyn Delayed-Reslease (naproxen)

10. Feldene (piroxicam)

11. Indocin (indomethacin)

12. Lodine (etodolac)

13. Mobic (meloxicam)

14. Motrin (ibuprofen)

15. Nalfon (fenoprofen calcium)

16. Naprelan (naproxen sodium controlled release)

17. Orudis (ketoprofen)

18. Ponstel (mefenamic acid)

19. Relafen (nabumetone)

20. Tolectin (tolmetin sodium)

21. Toradol (Ketorolac tromethamine tabs/injection)

22. Trilisate (choline magnesium trisalicylate)

23. Vioxx tabs/liquid (rofecoxib)

Exemplary Quality Audits/Quality Letters (Analgesics):

Therapeutic duplication of COX-2 Inhibitor medications;

Excess dosing (beyond PDR maximum daily recommendations);

Dosing Initiation Titration For Opioid Nieve patients (first time opioid);

Inadequate Dosing for Continuous Chronic Pain Control;

Drug/Drug Interactions (Pharmacokinetic and/or Pharmacodynamic);

Cost ineffective pill strength selection;

Use of two or more drugs from same chemical class (NSAIDS, narcotics);

No Timely Refill (adherence);

Brand versus Generic;

Patient with two or more physicians;

Use of narcotics For More Than Two Weeks for Non-Terminal Disease;

Quantity of Pills Prescribed;

Taking NSAID with Food or Cytoprotective Agent.

### Example III.

### Anesthetics

A. General Anesthetics

1. Diprivan Injectable Emulsion (propofol)

2. Fluothane (halothane inhalation)

3. Suprane Liquid for Inhalation (desflurane)

4. Versed Injection (midazolam)

B. Local Anesthetics

1. Adrenalin Chloride Injection (epinephrine inhalation solution)

2. Chrirocaine Injection (Levobupivacaine injection)

3. Duranest Injections (etidocaine HCL)

4. Naropin Injection (ropivacaine HCL injection)

5. Nesacaine Injection (chloroprocaine HCL injection)

6. Sarapin (salts of sarraceniacae—Pitcher Plant

7. Sensorcaine Injection/with epinephrine (bupivacaine HCL)

8. Xylocaine (lidocaine HCL injection)

Exemplary Quality Audits/Quality Letters (Anesthetics):

Inadequate Dosing;

Injection Rate To Fast;

Drug/Drug Interaction;

Duration of analgesia for procedure;

Brand versus generic;

Excess Dosing Amount and Rate of Injection;

### Example IV.

### Anticonvulsants

A. Barbiturates

1. Mabaral (mephobarbital)

2. Nembutal (pentobarbital)

B. Benzodiazepine Anticonvulsants

1. Ativan injection (lorazepam)

2. Diastat Rectal Delivery System (diazepam)

3. Klonopin (clonazepam)

4. Tranxene T-TAB (clorazepate)

5. Valium tabs/injectable (diazepam)

C. GABA Analogues

1. Gabitril Filmtab (Tiagabine HCL)

2. Neurontin (gabapentin)

D. Hydantoins

1. Cerebyx Injection (Fosphenytoin sodium injection)

2. Dilantin (phenytoin sodium)

E. Miscellaneous Anticonvulsants

1. Carbatrol (carbamazepine extended release capsules)

2. Depacon Injection (Valproate sodium injection)

3. Depakene (Valproic acid capsules and syrup)

4. Depakote (Divalproex sodium, delayed release)

5. Felbatol (felbamate)

6. Keppra (levetiracetam)

7. Mysoline (primidone)

8. Tegretol (carbamazepine)

9. Topamax (topiramate)

10. Trileptal (Oxcarbazepine)

11. Zonegran (zonisamide)

F. Phenyltriazines

1. Lamictal (lamotrigine)

G. Succinimides

1. Celontin (methsuximide)

2. Zarontin (ethosuximide)

Exemplary Quality Audits/Quality Letters (Anticonvulsants):

Excess Dosing (Therapeutic Plasma level ranges);

Inadequate Dosing (Therapeutic Plasma level ranges);

Drug/Drug Interactions (Pharmacokinetic or Pharamcodynamic);

Cost ineffective pill strength selection;

No Timely refill (patient adherence);

Brand versus generic;

Patient with two or more physicians;

Use of hypnotic anticonvulsants for greater than 2 weeks;

Directions for Use: Caregiver instruction/training (Diastat).

### Example V.

### Oral Antidiabetics

1. Glucophage (metformin)

2. Glucovance (glyburide/metformin)

3. Glyset (miglitol)

4. Precose (acarbose)

5. Insulins

6. Prandin (repaglinide)

7. Amaryl (glimepiride)

8. DiaBeta (glyburide)

9. Diabinese (chlorpropamide)

10. Glucotrol (glipizide)

11. Glocovance (glyburide and metformin)

12. Actos (pioglitazone)

13. Avandia (rosiglitazone)

Exemplary Quality Audits/Quality Letters:

Excess Dosing (Beyond PDR Recommended daily max);

Therapeutic Duplications of oral antidiabetics in same family;

Inadequate Dosing;

Drug/Drug Interactions;

Cost ineffective pill strength selection;

No timely refills (patient adherence);

Brand versus generic;

Patient with two or more physicians;

### Example VI.

### Anti-Infective Agents

A. AIDS Therapy

1. Reverse Transcriptase Inhibitors

a. Rescriptor (delavirdine mesylate)

b. Sustiva (efavirenz)

c. Viramune (nevirapine)

2. Nucleoside reverse transcriptase inhibitors

a. Combivir

b. Epivir

c. Hivid

d. Retrovir

e. Videx

f. Zerit

g. Ziagen

3. Protease Inhibitors

a. Agenerase

b. Crixivan

c. Fortovase

d. Invirase

e. Norvir

f. Vriacept

Exemplary Quality Audits/Quality Letters (AIDS Therapy):

Therapeutic Duplication of Non-Nucleoside Reverse Transcriptase;

Inhibitors, Nucleoside Reverse Transcriptase Inhibitors, or Protease Inhibitors;

Doses Beyond PDR Recommended Daily Maximum;

Dosing Below PDR Recommended Dose for Efficacy;

Drug/Drug Interactions (especially pharmacokinetic);

Cost Ineffective Pill Strength Selection;

Use of Two or More Drugs From the Same Chemical Class;

No Timely refill (patient adherence);

Patient with two or more physicians.

B. Antibiotics

1. Cephalosporins

a. Ceclor

b. Cedax

c. Ceftin

d. Cefzil

e. Ceptaz

f. Duricef

g. Keflex

h. Maxipime

i. Suprax

j. Zinacef

2. Macrolides

a. Biaxin

b. Dynatab

c. E.E.S.

d. Zithromax

3. Penicillins

a. Amoxil

b. Augmentin

c. Bicillin

d. Geocillin

4. Tetracyclines

a. Doryx

b. Achromycin V

c. Vibramycin

5. Quinolones

a. Cipro

b. Floxin

c. Levaquin

d. Maxaquin

e. NegGram

f. Tequin

g. Trovan

h. Zagam

6. Antifungals

a. Diflucan

b. Grifulvin V

c. Lamisil

d. Nizoral

e. Sporanox

Exemplary Quality Audit/Quality Letters (Antibiotics):

Therapeutic duplication of antibiotics;

Food Drug Interactions;

Drug/Drug Interactions (pharmacokinetic);

Pill Quantity Prescribed (Adequate length of therapy);

Over utilization of antibiotics;

Dosing Above the PDR Recommended Daily Maximum;

Dosing below the PDR Recommended Daily Effective amount;

Cost ineffective pill strength selection;

Brand versus generic;

Patient with two of more physicians.

### Example VII.

### Antiparkinsonin Agents

Akineton

Artane

Comtan (entacapone)

Tasmar

Eldepryl

Levsin

Mirapex (pramipexole)

Permax (pergolide mesylate)

Requip (ropinirole HCL)

Sinemet

Symmetrel

Exemplary Quality Audit/Quality Letters (Antiparkinsonian Drugs):

Therapeutic duplications of anticholinergics, or dopamine agonists;

Dosing Initiation and Titration of dopamine agonists;

Dosing Above the PDR Recommended Maximum Daily Amount;

Dosing Below the PDR Recommended Effective Minimal Dose;

Drug/Drug Interactions (Pharmacokinetic and/or pharmacodynamic);

Cost ineffective Pill Strength Selection;

No Timely Refills (patient adherence);

Brand versus generic;

Patient with two or more physicians.

### Example VIII.

### Biological Response Modifiers

Avonex

Betaseron

Intron A

Neupogen (filgrastim)

Prolukin

Rebetron

Remicade

Roferon-A

Exemplary Quality Audits/Quality Letters (Biological Response Modifiers):

Appropriate patient selection;

Dosing Initiation and Titration;

Timing of drug initiation in relation to cytotoxic chemotherapy;

Dosing Above the PDR Recommended Daily Maximum;

Drug/Drug Interactions;

Maximal Efficacy by Combining with PDR recommend drug.

### Example IX.

### Biologicals

Immume Serums

BayGam

BayHep B

CytoGam IV

Gamimune N

RhoGAM

Sandoglobulin IV

Vaccines

Fluogen

Fluzone

Havrix

Exemplary Quality Audits/Quality Letters (Biologicals):

Appropriate patient selection;

Dosing initiation and titration;

Timing of initiation of drug relative to symptoms.

### Example X.

### Cardiovasculars

ACE Inhibitors

Accupril

Aceon

Altace

Captopril

Lotensin

Mavik

Monopril

Prinivil

Univasc

Vasotec

Zestril

ACE II Receptor Antagonists

Atacand

Avapro

Cozaar

Diovan

Micardis

Teveten

Exemplary Quality Audits/Quality Letters (ACE Receptor Antagonists):

Therapeutic duplication of ACE Inhibitor or ACE II Inhibitors;

Dosing Beyond the PDR Maximum Daily Dose;

Dosing Below the PDR Effective Minimal Dose for Efficacy;

Drug/Drug Interaction (pharmacokinetic);

Cost ineffective pill strength selection;

Use of two or more drugs from the same chemical class;

No timely refill (patient adherence);

Brand versus generic;

Patient with two or more physicians.

### Example XI.

### Antiarrhythymics

Mexitil

Norpace

Procainbid

Quinaglute

Quinidex

Tambocor

Tonocard

Betapace

Inderal LA

Cordarone

Calan

Cardizem

Exemplary Quality Audits/Quality Letters (Antiarrhythymics):

Therapeutic duplication of two or more antiarrhythymics;

Dosing beyond the PDR recommended daily maximum dose;

Dosing below the PDR recommended minimal effective daily dose;

Drug/Drug interaction (pharmacokinetic);

No timely refills (patient adherence);

Brand versus generic;

Patient with two or more physicians;

Instructing patient to break a controlled release formulation unit;

### Example XII.

### HMG-CoA Reductase Inhibitors

Baycol

Lescol

Lipitor

Mevacor

Pravachol

Zocor

Exemplary Quality Audits/Quality Letters (HMG-COA Reductase Inhibitors):

Therapeutic duplications of HMG-CoA Reductase Inhibitors;

Dosing above the PDR recommended daily maximum dose;

Dosing below the PDR recommended daily minimal effective dose;

Drug/Drug Interactions (Pharmacokinetic);

Cost ineffective pill strength selection;

No timely refills (patient adherence);

Brand versus Generic;

Patient with two or more physicians.

### Example XIII.

### Beta Adrenergic Blocking Agents

Betapace

Blocadren

Cartrol Filmtab

Inderal LA

Kerlone

Nadolol

Sectral

Tenormin

Toprol XL

Zebeta

Exemplary Quality Audits/Quality Letters (Beta Blockers):

Therapeutic duplication of beta blockers;

Combination of a beta-1 selective beta blocker with a nonselective agent;

Dosing about the PDR recommended daily maximum dose;

Dosing below the PDR recommended daily minimal effective dose;

Drug/Drug interactions (pharmacokinetic/pharmacodynamic);

Cost ineffective pill strength selection;

No timely refills (patient adherence);

Brand versus generic;

Patient with two or more physicians;

Splitting sustained release formulations.

### Example XIV.

### Calcium Channel Blockers

Adalat

Calan

Calan SR

Cardizem CD

Covera—HS

Isoptin SR

Nimotop

Norvasc

Plendil

Procardia XL

Sular

Tiazac

Vascor

Verelan

Exemplary Quality Audits/Quality Letters (Calcium Channel Blockers):

Therapeutic duplication of two or more calcium channel blockers;

Dosing above the PDR recommended daily maximum dose;

Dosing below the PDR recommended daily minimal effective dose;

Drug/Drug interactions (pharmacokinetic or pharmacodynamic);

Splitting sustained release formulations;

Cost ineffective pill strength selection;

No timely refills (patient adherence);

Brand versus generic;

Patient with two or more physicians.

### Example XV.

### Miscellaneous Cardiovascular Agents/Fibrin-Specific Thrombolytic Agents

Activase IV (Alteplase)

Retavase (Retaplase)

TNKase (Tenecteplase)

Demser (Metyrosine)

Inversine

ReoPro

Streptase for infusion

Exemplary Quality Audits/Quality Letters (Miscellaneous CV Agents):

Appropriate patient selection;

Initiation of drug soon enough after the event for it to be effective;

Dose above the mg/kg recommendations in the PDR;

Injected within the PDR recommended time period (bolus/infusion length);

Drug/Drug interactions (pharmacokinetic and pharmacodynamic);

Patient instructions regarding adequate water intake with Demser;

Dosing below the PDR recommended optimally effective daily dose;

Contraindicated in acute MI patients at increased risk of bleeding (fibrin-specific thrombolytic agents).

### Example XVI.

### Vasodilators

Imdur

Ismo (isosorbide mononitrate)

Isordil sublingual

Nitro-Dur Transdermal Systems

Nitrolingual Pumpspray

Nitrostat tablets

Exemplary Quality Audits/Quality Letters (Vasodilators):

Therapeutic duplication of vasodilators;

Correct dosing interval between doses;

Dosing above the PDR recommended daily maximum dose;

Dosing below the PDR recommended optimally effective daily dose;

Cost ineffective pill strength selection;

No timely refills (patient adherence);

Brand versus generic;

Patient with two or more physicians;

Patient instructions for use of transdermal patches;

Repackaging of nitroglycerin tablets.

### Example XVII.

### CNS Stimulants (for ADHD/Other)

Amphetamines

Adderall

Desoxyn

Dexedrine Spansule

Dexedrine Tablets

DextroStat Tablets

Miscellaneous CNS Stimulants

Concerta

Cylert

Dopram

Medadate ER

Methylin ER

Provigil

Ritalin IR/SR

Exemplary Quality Audits/Quality Letters (Stimulants):

Therapeutic duplications of psychostimulants;

Dosing above the PDR recommended daily maximum dose;

Drug/Drug Interactions (pharmacokinetic and pharmacodynamic);

Cost ineffective pill strength selection;

Brand versus generic;

Patient with two or more physicians;

### Example XVIII.

### Erectile Dysfunction (ED) Therapy

Viagra

Exemplary Quality Audits/Quality Letters (ED Drugs):

Drug/Drug interactions: (pharmacokinetic/pharmacodynamic);

Contraindication with nitrates (inhaled or oral);

Patient with two or more physicians;

Prescription of large quantity of tablets per Rx (i.e. over tablets per Prescription);

### Example XIX.

### Gastrointestinal Agents

Antiemetics

Anzemet (dolasetron mesylate) tablets

Kytril injection

Marinol

Reglan

Transderm Scop Transdermal System

Zofran Tablets/injection

Exemplary Quality Audit/Quality Letters (Antiemitics):

Therapeutic duplication of 5-HT3 blockers;

Dosing above the PDR recommended daily maximum dose;

Dosing below the PDR recommended optimally effective daily dose;

Drug/Drug Interactions (pharmacokinetic and pharmacodynamic);

Cost ineffective pill strength selection;

Brand versus generic;

Patient with two or more physicians;

Prescription of large quantity of 5-HT3 blockers per Rx (i.e. over 30 Tablets per prescription).

### Example XX.

### Anti-Inflammatory Agents (IBS, Chron's, Ulcerative Colitis)

Asacol Delayed-Release

Azulfadine EN tablets (sulfasalazine delayed release tablets)

Colazal capsules

Dipentum capsules (olsalazine sodium capsules)

Pentasa capsules (mesalamine controlled release)

Exemplary Quality Audit/Quality Letters (Irritable Bowl Syndrome/Chron's):

Therapeutic duplication of IBS/Chron's Drugs in same chemical class;

Dosing above the PDR recommended daily maximum dose;

Dosing below the PDR Recommended optimally effective dose;

Drug/Drug interactions (pharmacokinetic/pharmacodynamic);

Cost ineffective pill strength selection;

No timely refills (patient adherence);

Brand versus generic;

Patient with two or more physicians;

Splitting sustained release formulations;

### Example XXI.

### Doudenal Ulcer Adherent Complex

Carafate tables/suspension

Exemplary Quality Audit/Quality Letters (Adherent Complex Drugs):

Therapeutic duplication with other adherent complex drugs;

Instructions to take on empty stomach;

Instructions to administer carafate 2 hours after other medications;

Daily Use beyond 8 weeks (If used longer than 8 weeks, reduce dose to 1 g BID);

Drug/Drug Interactions (pharmacokinetic and pharmacodynamic);

Dosing above PDR recommended daily maximal dose;

Dosing below PDR recommended optimally effective daily dose;

Brand versus generic;

Patient with two or more physicians.

### Example XXII.

### Histamine (H2) Receptor Antagonists

Axid

Pepcid

Tagamet

Zantac

Proton Pump Inhibitors

Aciphex tablets

Prevacid Delayed-Release Capsules

Prilosec Delayed-Release Capsules

Protonix

Exemplary Quality Audit/Quality Letters (H2 Blockers and Proton Pump Inhibitors):

Therapeutic duplications of H2 blockers;

Therapeutic duplications of proton pump inhibitors;

Dosing above PDR recommended daily maximal dose;

Dosing below PDR recommended optimally effective dose;

Brand versus generic;

Patient with two or more physicians;

Drug/Drug interactions (pharmacokinetic/pharmacodynamic);

Cost ineffective pill strength selection;

Patient with two or more physicians;

No timely refills (patient adherence).

### Example XXIII.

### Migraine Preparations

Serotonin (5-HT) Receptor Agonists

Amerge (naratriptan)

Imitrex

Maxalt (rizatriptan benzoate)

Zomig (zolmitriptan)

Exemplary Quality Audit/Quality Letters (Serotonin Receptor Agonists):

Therapeutic duplication of 5-HT receptor agonists for migraine;

Dosing above the PDR recommended daily maximal dose;

Dosing below the PDR recommended optimally effective dose;

Brand versus generic;

Drug/Drug interactions (pharmacokinetic/pharmacodynamic);

Cost ineffective pill strength selection;

Patient with two or more physicians;

Quantity of pills prescribed per Rx (i.e. not over 10 pills);

Patient information/instruction on use;

Not for patients with ischemic heart disease, history of MI, or uncontrolled Hypertension;

Not to be used with MAO inhibitors or within 2 weeks of discontinuation of MAO inhibitors.

### Example XXIV.

### Obesity Management

Appetite Suppressants

Adipex-P

Bontril Slow-Release Capsules

Desoxyn Tablets

Ionamin capsules

Meridia capsules

Lipase Inhibitors

Xenical capsules

Exemplary Quality Audit/Quality Letters (Obeisty):

Therapeutic duplications of stimulant antiobesity drugs;

Dosing above the PDR recommended daily maximal dose;

Dosing below the PDR recommended optimally effective daily dose;

Drug/Drug interactions (pharmacokinetic/pharmacodynamic);

Cost ineffective pill strength selection;

Adequate patient instructions;

Brand versus generic;

Patient with two or more physicians.

### Example XXV.

### Psychotherapeutic Agents (Behavioral Pharmacy Medications)

Antianxiety Agents/Benzodiazepines and Combinations

Ativan

Librium

Limbitrol

Tranxene

Valium

Xanax

Azapirones

Buspar (buspirone)

Miscellaneous Antianxiety Agents

Atarax

Effexor XR

Mebaral tablets

Miltown

Paxil

Sinequan

Vistaril

Antidepressants

Effexor/Effexor XR

Remeron

Serzone

Wellutrin/Wellbutrin SR

Celexa

Paxil

Prozac/Sarafem

Zoloft

Luvox

Elavil injection

Elavil tablets

Etrafon 2-10

Limbitrol

Norpramin

Sinequan

Surmontil

Vivactil

Antimanic

Depakote

Eskalith

Eskalith CR

Lithium carbonate

Lithobid

Antipanic

Klonopin tablets

Paxil tablets/suspension

Xanax

Zoloft tablets/concentrate

Antipsychotics: Atypicals

Abilitat

Clozaril

Risperdal

Seroquel

Zyprexa

Zyprexa ZYDIS

Ziprasidone

Antipsychotics: Typical

Compazine

Serentil

Stelazine

Mellaril

Thorazine

Haldol/Haldol Decanoate

Loxitane

Moban

Navane

Orap

Sedative/Hypnotics (Non-Benzodiazepine)

Ambien

Sonata

Exemplary Quality Audit/Quality Letters (Psychtropics-Behavioral Drugs):

Therapeutic duplications of atypical antipsychotics;

Dosing above the PDR recommended maximal daily amount;

Dosing below the PDR recommended optimally effective dose;

Drug/Drug interactions (pharmacokinetic or pharmacodynamic);

Cost ineffective pill strength selection;

Use of two or more drugs from the same chemical class;

No timely refills (patients adherence);

Brand versus generic;

Patient with two or more physicians;

Use of sedative/hypnotics for greater than 30 days;

SSRIs, Serzone, Effexor, Remeron, Wellbutrin, Zyban used in combination with MAOIs.

### Example XXVI.

### Respiratory Agents

Steroidal Anti-inflammatory Agents

Aerobid Inhaler system

Azmacort Inhalation

Beclovent Inhalation

Flovent

Pulmicort

Vanceril

Bronchodilators

Atrovent Aerosol and Solution

Combivent Aerosol

Alupent

Brethine

Maxair

Proventil

Rynatuss

Serevent Diskus

Ventolin

Volmax ER tablets

Xopenex Inhalation Solution (levalbuterol)

Aerolate capsules/liquid

Cafcit

Lufyllin

Theo-24 Extended Release Capsules

Theo-Dur Extended Release Capsules

Uni-Dur

Uniphyl

Decongenstants/Allergy

Allegra-D Extended Release

Alumadrine tablets

Bronfed capsules

Claritin and Claritin-D

Accolate tablets

Singulair tablets

Zyrtec tablets/syrup

Exemplary Quality Audit/Quality Letters (Respiratory Drugs):

Therapeutic duplications of theophylline products;

Therapeutic duplications of inhaled bronchodilators;

Therapeutic duplications of inhaled steroidal intiinflamatory agents;

Therapeutic duplications of non-sedating allergy drugs;

Dosing above the PDR recommended daily maximal dose;

Dosing below the PDR recommended daily optimally effective dose;

Drug/Drug Interactions (pharmacokinetic/pharmacodynamic);

Instructions for patients on use of inhaler devices;

Cost ineffective pill strength selection;

No timely refills (patient adherence);

Brand versus generic;

Patient with two or more physicians.

### Example XXVII.

### Smoking Cessation Aids

Nicoderm CQ

Nicorette Gum

Nicotrol Inhaler

Nicotrol Nasal Spray

Nicotrol Patch

Zyban SR Tablets (bupropion)

Exemplary Quality Audit/Quality Letters (Smoking Cessation Aids):

Therapeutic duplications of nicotine replacement products;

Dosing Initiation and Titration process;

Length of use beyond six months for nicotine products; Use of Zyban for smoking cessation beyond 4 months;

Patient instruction for when to stop smoking in relation to starting Zyban;

Use of MAO Inhibitors with Zyban;

Patient with two or more physicians;

Drug/Drug interaction (pharmacokinetic/pharmacodynamic);

Dosing above PDR recommended maximal daily doses;

Dosing below PDR recommended daily optimally effective doses.

### Example XXIX.

### Urinary Tract Agents: (BPH)

Cardura Tablets

Flomax capsules

Hytrin

Proscar (finasteride)

Exemplary Quality Audits/Quality Letters (BPH Drugs):

Therapeutic duplications of BPH drugs with same mechanism;

Dosing above PDR recommended daily maximal doses;

Dosing below PDR recommended daily minimally effective doses;

Drug/Drug interactions (pharmacokinetic/pharmacodynamic);

Cost ineffective pill strength selection;

Brand versus generic;

No timely refill (patient adherence);

Patient with two or more physicians.

While the present invention has been described with respect to a selected embodiment thereof, it will be appreciated by those skilled in the art that various modifications and variations of the invention are possible with departing from the spirit and scope of the appended claims.

We claim:

1. A method for providing an intervention information based solely on prescription data, said method comprising the steps of:
providing a prescription data;
providing a reference guideline;
defining a comparative metric;
comparing said prescription data to said reference guideline on a basis of said metric;
computing a deviation of said metric as a difference between said prescription data and said reference guideline;
comparing said deviation to a threshold deviation; and
if said deviation exceeds said threshold deviation, providing said intervention information.

2. The method according to claim 1, wherein the prescription data comprises:
a patient name;
a health plan identification information;
a prescriber identification or DEA number;
a drug code;
a dosage;
a number of dosing units dispensed;
a number of available refills;
a prescription date; and
a prescription cost.

3. The method according to claim 1, wherein said comparative metric comprises a therapeutic duplication of an atypical drug.

4. The method according to claim 1, wherein said comparative metric comprises an excess dosing.

5. The method according to claim 1, wherein said comparative metric comprises an inadequate dosing.

6. The method according to claim 1, wherein said comparative metric comprises a drug-drug interaction.

7. The method according to claim 1, wherein said comparative metric comprises a cost ineffective pill strength.

8. The method according to claim 1, wherein said comparative metric comprises a use of two or more drugs from a same chemical class.

9. The method according to claim 1, wherein said comparative metric comprises an absence of a timely refill.

10. The method according to claim 1, wherein said comparative metric comprises a prescription for a brand-name drug when a chemically equivalent generic exists.

11. The method according to claim 1, wherein said comparative metric comprises a patient having a plurality of prescribing physicians.

12. The method according to claim 1, wherein said comparative metric comprises a patient having a sedative or a hypnotic prescribed for in excess of a threshold number of days.

13. The method for reviewing and analyzing a pharmaceutical prescription according to claim 12, wherein said threshold number of days is 30.

14. The method according to claim 1, wherein said intervention information comprises a letter.

15. The method according to claim 14, wherein said intervention information further includes a reference to a published information.

16. The method according to claim 15, wherein a copy of said published information is provided together with said intervention information.

17. The method according to claim 1, wherein said intervention information comprises an e-mail.

18. The method according to claim 17, wherein said intervention information further includes a reference to a published information.

19. The method according to claim 1, wherein said intervention information comprises a telephone call.

20. The method according to claim 1, wherein said intervention information comprises a personal interview.

21. A computer system having a computer program set of instructions stored thereon that when executed can perform a method for providing an intervention information based solely on a pharmaceutical prescription, said system comprising:
a computer;
a first memory connected to said computer, said first memory having a computer program set of instructions for performing a method for reviewing and analyzing a pharmaceutical prescription stored thereon;
a second memory connected to said computer, said second memory having at least one pharmaceutical prescription record stored thereon; and
a third memory connected to said computer, said third memory having at least one expert guideline stored thereon.

22. The computer system as claimed in claim 21 further comprising an output comprising an intervention information.

23. The computer system as claimed in claim 22 wherein said intervention information further comprises a reference to said at least one expert guideline.

24. The computer system as claimed in claim 23 wherein said intervention information further comprises a copy of said said at least one expert guideline.

25. The computer system as claimed in claim 21 further comprising:
an output device for outputting an intervention information.

26. A computer program for providing an intervention information based solely of data derived from a pharmaceutical prescription data, said computer program comprising a plurality of programed intervention informations outputs.

27. The computer program as claimed in claim 26 wherein said plurality of programed intervention informations outputs includes a therapeutic duplication intervention information.

28. The computer program as claimed in claim 26 wherein said plurality of programed intervention informations outputs includes an excess dosing intervention information.

29. The computer program as claimed in claim 26 wherein said plurality of programed intervention informations outputs includes an inadequate dosing intervention information.

30. The computer program as claimed in claim 26 wherein said plurality of programed intervention informations outputs includes a drug-drug interaction intervention information.

31. The computer program as claimed in claim 26 wherein said plurality of programed intervention informations outputs includes a cost-ineffective pill strength selection intervention information.

32. The computer program as claimed in claim 26 wherein said plurality of programed intervention informations outputs includes a multiple drugs-same chemical class intervention information.

33. The computer program as claimed in claim 32 wherein said multiple drugs are prescribed by multiple prescribers.

34. The computer program as claimed in claim 26 wherein said plurality of programed intervention informations outputs includes a patient adherence intervention information.

35. The computer program as claimed in claim 26 wherein said plurality of programed intervention informations outputs includes a brand-name prescribed when generics available intervention information.

36. The computer program as claimed in claim 26 wherein said plurality of programed intervention informations outputs includes a long-term usage intervention information.

37. An intervention information based solely on data derived from a pharmaceutical prescription data, said intervention information produced by a process of:
providing a prescription data;
providing a reference guideline;
defining a comparative metric;
comparing said prescription data to said reference guideline on a basis of said metric;
computing a deviation of said metric as a difference between said prescription data and said reference guideline;
comparing said deviation to a threshold deviation; and
if said deviation exceeds said threshold deviation, providing said intervention information.
